(19) United States
(12) Patent Application Publication
(10) Pub. No.: US 2024/0370709 A1
(43) Pub. Date: Nov. 7, 2024

(54) ENTERPRISE GENERATIVE ARTIFICIAL INTELLIGENCE ANTI-HALLUCINATION AND ATTRIBUTION ARCHITECTURE

(71) Applicant: C3.ai, Inc., Redwood City, CA (US)

(72) Inventors: Thomas M. Siebel, Woodside, CA (US); Sina Khoshfetrat Pakazad, Redwood City, CA (US); Romain Juban, San Francisco, CA (US); Michael Haines, San Francisco, CA (US); Louis Poirier, Paris (FR)

(21) Appl. No.: 18/651,650

(22) Filed: Apr. 30, 2024

Related U.S. Application Data
(63) Continuation-in-part of application No. 18/542,481, filed on Dec. 15, 2023.
(63) Continuation-in-part of application No. 18/542,536, filed on Dec. 15, 2023.
(63) Continuation-in-part of application No. 18/542,583, filed on Dec. 15, 2023.
(60) Provisional application No. 63/499,485, filed on May 1, 2023.

(51) Int. Cl. G06N 3/0475

(52) U.S. Cl. CPC G06N 3/0475

(57) ABSTRACT

An anti-hallucination and attribution architecture for enterprise generative AI systems is disclosed herein which increases the accuracy and reliability of generative artificial intelligence content (e.g., responses or answers) by detecting, preventing, and mitigating hallucination. The anti-hallucination and attribution architecture can be added to deployed generative artificial intelligence systems as a separate tool or module, which allows it to work with the deployed systems without having to retool or redesign those systems. The anti-hallucination and attribution architecture can also be deployed with minimal impact on live production systems.

### CROSS-REFERENCE TO RELATED APPLICATIONS

The present application claims the benefit of U.S. Provisional Patent Application Ser. No. 63/499,485 filed May 1, 2023, and entitled “Systems and Methods for Parallelized Model Management,” which is hereby incorporated by reference herein. The present application is a continuation-in-part of U.S. Nonprovisional patent application Ser. No. 18/542,481 filed Dec. 15, 2023, and entitled “Generative Artificial Intelligence Enterprise Search,” U.S. Nonprovisional patent application Ser. No. 18/542,536 filed Dec. 15, 2023, and entitled “Enterprise Generative Artificial intelligence Architecture,” and U.S. Nonprovisional patent application Ser. No. 18/542,583 filed Dec. 15, 2023, and entitled “Generative Artificial Intelligence Crawling and Chunking,” each of which is hereby incorporated by reference herein.

### TECHNICAL FIELD

This disclosure pertains to generative artificial intelligence and machine learning. More specifically, this disclosure pertains to anti-hallucination and attribution architectures for enterprise generative artificial intelligence.

### BACKGROUND

Generative artificial intelligence (generative AI) refers to a subfield of machine learning concerned with algorithms that can generate new data instances. These algorithms are typically deep learning models trained on large datasets to learn the underlying statistical properties of the data. Generative artificial intelligence approaches employ artificial neural networks to mimic statistical properties of large training data. Different from conventional AI approaches, which might focus on analyzing existing data or completing specific tasks based on pre-defined rules, Generative AI can create entirely new output using its learned understanding of the data. Conventional generative AI approaches suffer from a variety of drawbacks, such as hallucination and an inability for users to verify or corroborate generative artificial intelligence responses.

### BRIEF DESCRIPTION OF THE DRAWINGS

FIG. 1 depicts a diagram of an example logical flow of an enterprise generative artificial intelligence system with an anti-hallucination and attribution architecture according to some embodiments.

FIG. 2 depicts a diagram of an example parsing and information graph generation process for enterprise generative artificial intelligence system using an anti-hallucination and attribution architecture according to some embodiments.

FIG. 3 depicts a flowchart of an example anti-hallucination and attribution process for enterprise generative artificial intelligence systems according to some embodiments.

FIG. 4 depicts a diagram of an example structure of response segments generated by an anti-hallucination and attribution method for enterprise generative artificial intelligence systems according to some embodiments.

FIG. 5 depicts a diagram of an example enterprise generative artificial intelligence system architecture and environment according to some embodiments.

FIG. 6A depicts an example enterprise search graphical user interface and underlying architecture according to some embodiments.

FIG. 6B depicts an example enterprise generative artificial intelligence response graphical user interface according to some embodiments.

FIG. 7 depicts a diagram of an example layered architecture and environment of an enterprise generative artificial intelligence system according to some embodiments.

FIG. 8 depicts a diagram of an example network system for enterprise generative artificial intelligence according to some embodiments.

FIG. 9 depicts a flowchart of an example iterative generative artificial intelligence process using unstructured data according to some embodiments.

FIG. 10A depicts a flowchart of an example iterative generative artificial intelligence process using unstructured data according to some embodiments.

FIG. 10B depicts a flowchart of an example non-iterative generative artificial intelligence process using unstructured data according to some embodiments.

FIG. 10C depicts a flowchart of an example non-iterative generative artificial intelligence process using unstructured data according to some embodiments.

FIG. 11 depicts a flowchart of an example iterative generative artificial intelligence process using unstructured data according to some embodiments.

FIG. 12 depicts a flowchart of an example enterprise generative artificial intelligence method according to some embodiments.

FIG. 13 depicts a flowchart of an example enterprise generative artificial intelligence method using an agent-orchestrator architecture according to some embodiments.

FIG. 14 depicts a flowchart of an example anti-hallucination and attribution method for enterprise generative artificial intelligence systems according to some embodiments.

FIG. 15 depicts a flowchart of an example information retrieval method for enterprise generative artificial intelligence method according to some embodiments.

FIG. 16 depicts a flowchart of an example method of routing requests to different agent programs and validating responses for enterprise generative artificial according to some embodiments.

FIG. 17 depicts a diagram of an example computer system for implementing the features disclosed herein according to some embodiments.

### DETAILED DESCRIPTION

Generative AI is an artificial intelligence technology that uses machine learning algorithms to perform tasks that imitate human cognitive intelligence and generate content. Content can be in the form of text, audio, video, images, and more. However, conventional generative artificial intelligence processes often present biased or faulty information as a result of machine learning model hallucination (or, simply, hallucination). In generative AI, an artificial hallucination, confabulation, or delusion, refers to a specific type of output generated by the model that deviates from factual accuracy, ground truth, or the intended context. Conventional generative AI can create content that does not correspond to reality or verifiable information; commonly contributed to by statistical inaccuracy, model overfitting, and data bias. The generated content may appear plausible and be internally coherent but lack accuracy and coherence with the provided prompt or surrounding information. Enterprise environments can also include contradictory information, which further increases the likelihood of hallucination. Hallucination in enterprise environments can is complicated by often incomplete and disparate information that is spread across a variety of different, and incompatible, enterprise systems. Currently generative Al systems fail to detect, prevent, or mitigate hallucination. Conventional generative artificial intelligence processes also fail to provide any mechanism for users to verify, validate, or corroborate generative artificial intelligence content. Accordingly, users have no way of knowing if generative artificial intelligence content is accurate or the result of hallucination.

An anti-hallucination and attribution architecture for enterprise generative AI systems is disclosed herein which increases the accuracy and reliability of generative artificial intelligence content (e.g., responses or answers) by detecting, preventing, and mitigating hallucination. Moreover, the anti-hallucination and attribution architecture can be added to deployed generative artificial intelligence systems as a separate tool or module, which allows it to work with the deployed systems without having to retool or redesign those systems. The anti-hallucination and attribution architecture can also be deployed with minimal impact on live production systems.

The enterprise generative artificial intelligence systems described herein can transform interactions with enterprise information that fundamentally changes the human-computer interaction (HCI) model for enterprise software. Enterprises running sensitive workloads in cloud-native, on premise, or air-gapped environments can implement enterprise generative Al architectures to generate enterprise-wide insights using tools to rapidly locate and retrieve information with agents that develop and coordinate complex operations in response to simple intuitive input. The enterprise generative AI architecture enables enterprise users to ask open-ended, multi-level, context specific questions that are processed used generative AI with machine learning to understand the request, identify relevant information, and generate new context specific insights with predictive analysis. The enterprise generative AI architecture supports simplified human-computer-interactions with intuitive natural language interface as well as advanced accessibility features for adaptable forms of input including but not limited to text, audio, video, images, and more.

The anti-hallucination and attribution architecture includes an anti-hallucination and attribution module that can work with deployed enterprise generative artificial intelligence systems and components (e.g., retriever tools, large language models or other generative artificial intelligence models, etc.) in order to detect, prevent, and mitigate hallucination caused by the deployed large language models or other models (e.g., generative artificial intelligence models, multimodal models). For example, a user can submit a prompt (e.g., question, query, etc.) to the enterprise generative artificial intelligence system, such as “How many different engineers has John Doe worked with within his engineering department?” This may require the enterprise generative artificial intelligence system to identify John Doe, identify John Doe's department, determine the engineers in that department in a third iteration, determine which of those engineers John Doe has interacted with, and then finally combine those results, to generate the answer to the query. Such complex queries can introduce hallucination at any of step along the way to generating the answer. For example, there may be several John Doe's within an organization, and the system could easily hallucinate in order to determine which John Doe the query is referring to. The anti-hallucination and attribution architecture can prevent or mitigate such hallucination by providing the answer to an anti-hallucination and attribution module prior to generating a final answer.

The anti-hallucination and attribution module can parse the answer generated by the enterprise generative artificial intelligence system into several chunks (e.g., several sentences). The anti-hallucination and attribution module can process the chunks along with the original passages retrieved by the enterprise generative artificial intelligence system in order to find relevant passages for each chunk. The anti-hallucination and attribution module can then combine the chunks and the retrieved relevant passages to generate an attributed answer. For example, the attributed answer may include source identifiers that indicate the documents and passages that were used to generate the answer. Accordingly, the system provides traceable attribution to confirm that the answer is reliable, and the model was not hallucinating. If the anti-hallucination and attribution module cannot locate any relevant passages, the anti-hallucination and attribution module may determine that the model hallucinated and either re-run the query to find another result or notify the user that a reliable result could not be determined, rather than merely providing the response to the user.

The enterprise generative artificial intelligence systems described herein can further use a combination of agents and tools to efficiently process a wide variety of inputs received from disparate data sources (e.g., having different data formats) and return results in a common data format (e.g., natural language). The enterprise generative artificial intelligence architecture includes an orchestrator agent (or, simply, orchestrator) that supervises, controls, and/or otherwise administrates many different agents, tools, and/or modules (e.g., an anti-hallucination and attribution module). Orchestrators can include one or more machine learning models and can execute supervisory functions, such as routing inputs (e.g., queries, instruction sets, natural language inputs or other human-readable inputs, machine-readable inputs) to specific agents to accomplish a set of prescribed tasks (e.g., retrieval requests prescribed by the orchestrator to answer a query). Machine learning models can include some or all of the different types or modalities of models described herein (e.g., multimodal machine learning models, large language models, data models, statistical models, audio models, visual models, audiovisual models, etc.). Agents can include one or more multimodal models (e.g., large language models) to accomplish the prescribed tasks using a variety of different tools. Different agents can use various tools to execute and process unstructured data retrieval requests, structured data retrieval requests, API calls (e.g., for accessing artificial intelligence application insights), and the like. Tools can include one or more specific functions and/or machine learning models to accomplish a given task (or set of tasks).

Agents can adapt to perform differently based on contexts. A context may relate to a particular domain (e.g., industry) and an agent may employ a particular model (e.g., large language model, other machine learning model, and/or data model) that has been trained on industry-specific datasets, such as healthcare datasets. The particular agent can use a healthcare model when receiving inputs associated with a healthcare environment and can also easily and efficiently adapt to use a different model based on different inputs or context. Indeed, some or all of the models described herein may be trained for specific domains in addition to, or instead of, more general purposes. The enterprise generative artificial intelligence architecture leverages domain specific models to produce accurate context specific retrieval and insights.

The orchestrator manages the agents to efficiently process disparate inputs or different portions of an input. For example, an input may require the system to access and retrieve data records from disparate data sources (e.g., unstructured datastores, structured datastores, timeseries datastores, and the like), database tables from different types of databases, and machine learning insights from different machine learning applications. The different agents can each separately, and in parallel, handle each of these requests, greatly increasing computational efficiency.

Agents can process the disparate data returned by the different agents and/or tools. For example, large language models typically receive inputs in natural language format. The agents may receive information in a non-natural language format (e.g., database table, image, audio) from a tool and transform it into natural language describing the tool output in a format understood by large language models. A model (e.g., large language model, multimodal model) can then process that input to generate an initial answer, which the anti-hallucination and attribution module can validate and/or attribute prior to providing a final output.

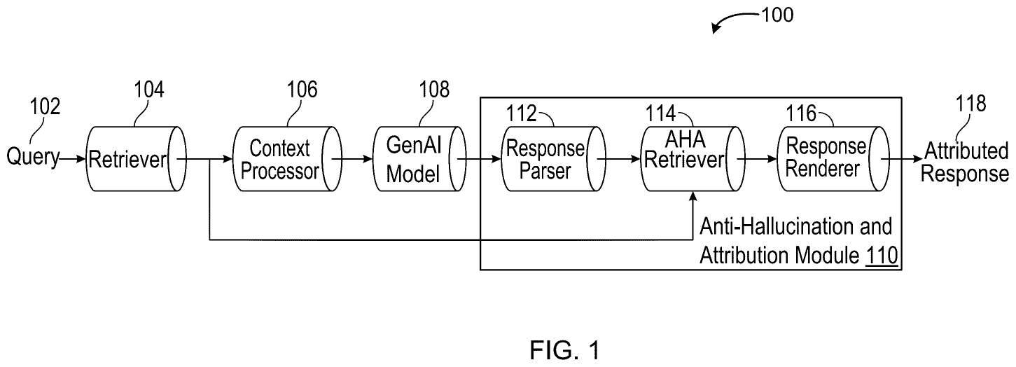

FIG. 1 depicts a diagram 100 of an example logical flow of an enterprise generative artificial intelligence system with an anti-hallucination and attribution architecture according to some embodiments. Generally, generative artificial intelligence models (e.g., large language models, multimodal models) have different capabilities and follow instructions with varying levels of performance. In one example, an enterprise generative artificial intelligence system can generate attributions (e.g., source citations) for responses generated by the enterprise generative artificial intelligence system (e.g., by a large language model) through prompting the generative artificial intelligence model to cite its sources. However, this approach has several drawbacks and limitations.

More specifically, different models may be able to follow this instruction or not, and this can depend on the particular model used by the enterprise generative artificial intelligence system, as well as the task or query that is received. The formatting of the source hash definition used by the enterprise generative artificial intelligence system to obtain citations can be different from customer to customer which in turn affects the citation performance. This approach can also limit the system's ability to cite only from the initially retrieved documents. This can potentially cause the system to ignore important or relevant documents (e.g., because the system did not pick a sufficiently high enough value for the number of retrieved documents which may vary from query to query) and prevents the system from reaping the potential benefits of leveraging a fine-tuned model on a customer corpus associated with enterprise generative artificial intelligence system.

Moreover, while this attribution approach may reduce hallucination to some degree, it still does not fully or optimally prevent hallucinations. Since generating attributions and preventing hallucinations are extremely important for enterprise generative artificial intelligence systems, it cannot be left to chance that the model would follow the instructions (e.g., instructions to cite sources). Indeed, the enterprise generative artificial intelligence systems described herein may be model-agnostic, and some models may implement such an approach very poorly. That is, this attribution approach is compatible with different types of models include proprietary or open source large language models (LLMs), small language models, image generation models, audio generation models, video generation models, omni-modal models, etc. Accordingly, an approach is needed that not only prevents hallucinations but is also model-agnostic.

For example, rather than prompting the model to cite its sources, the enterprise generative artificial intelligence system performs attribution as a separate step after the model has generated its response. This can address the limitations discussed above and also allows the system while using information in retrieved passages to also rely on the information encoded in a fine-tuned model on their corpus. The system can combine local and global search in the corpus to provide better and more informative responses. This enables the system to use this new component (e.g., anti-hallucination and attribution module 110) as a separate tool which can be used to fact check statements and provide corroborating statements.

An overview of the current architecture for anti-hallucination and attribution is shown in FIG. 1. In the example of FIG. 1, a query 102 is received (e.g., a question received from a user through a graphical user interface). The query 102 is passed to retriever 104 to retrieve passages (e.g., from a vector store) that are relevant to the query (e.g., using a similarity evaluation that generates a corresponding similarity score). The retriever 104 passes the retrieved passages through a context processor 106 that forms a prompt that is then provided to the generative artificial intelligence model 108 for generating the response. In the new design, rather than merely providing the response to the user, the system applies the anti-hallucination and attribution module 110 to this response. The response can initially go through a response parser 112 that parses the response into chunks (or, segments) to be attributed. These chunks and the original retrieved passages are processed by the anti-hallucination and attribution (AHA) retriever 114 to locate and retrieve (e.g., from a vector store) relevant passages for each chunk. The chunks together with their corresponding retrieved passages arc then provided to the response renderer 116 that combines the corresponding retrieved passages and the chunks to generate the attributed response 118.

The anti-hallucination and attribution module 110 can parse and chunk the response. To this end, the anti-hallucination and attribution module 110 can break up, segment, or select a subset of the response into sentences and contiguous pieces. These pieces or portions are then combined by the anti-hallucination and attribution module 110 into bigger chunks until it reaches a maximum number of tokens in each chunk. For computing the tokens, the anti-hallucination and attribution module 110 can utilize a tokenizer chosen to be the same tokenizer used by the embedding model in the anti-hallucination and attribution retriever 114. Each of the chunks are then fed through anti-hallucination and attribution retriever 114 to generate relevant passages to each chunk. Furthermore, in this stage the anti-hallucination and attribution module 110 has the option to limit or filter the passages used for attribution to the original passages retrieved in the beginning of the pipeline (e.g., by setting a tag value). These passages together with the chunks are then passed to the response renderer 116 to generate the attributed response 118. In this stage, the anti-hallucination and attribution module 110 has the option to include several passages for supporting each chunk. This can be controlled through a parameter value. For example, if set to a value larger than 1 the anti-hallucination and attribution module 110 can cite more passages for each chunk only if their score is larger than a certain threshold value of the anti-hallucination and attribution retriever 114. The anti-hallucination and attribution module 110 can always include at least one citation for each chunk, though the anti-hallucination and attribution module 110 may only include more if the score associated to the passage is larger than the threshold. The anti-hallucination and attribution module 110 can also provide a visualization such as a color code based on the maximum score of the cited passages for the chunk.

In one example, an original response generated by the generative artificial intelligence model 108 can include the following:
Parcel B1 is an approximately 40-50 acre property and adjacent wharf infrastructure purpose-built for marshalling (with dredged berth pockets and turning basin) (“Parcel B1”). The development of Parcel A is targeted to be completed in Quarter 2 of 2024, with the completion of the development of the balance of Phase 1 anticipated in 2024 and 2025. Development of Phase 2 is targeted to commence in 2024 and to achieve completion by 2028. The costs of development of Phases 1 and 2 are estimated at approximately $550 million each, excluding hydraulic dredging undertaken by the Department of Transportation. The Authority is issuing bonds to cover some of these costs.

The corresponding attributed response generated by the anti-hallucination and attribution module 110 can include the following:
Parcel A is targeted to be completed in Quarter 2 of 2024, with the completion of the development of the balance of Phase 1 anticipated in 2024 and 2025. Development of Phase 2 is targeted to commence in 2024 and to achieve completion by 2028 (from with score 0.7580196261405945). The costs of development of Phases 1 and 2 are estimated at approximately $550 million each, excluding hydraulic dredging undertaken by the Department of Transportation. The Authority is issuing bonds to cover some of these costs (from with score 0.8340072631835938). Parcel B1 is an approximately 40-50 acre property and adjacent wharf infrastructure purpose-built for marshalling (with dredged berth pockets and turning basin) (“Parcel B1”) (from with score 0.7503519654273987). The development of Parcel A is targeted to be completed in Quarter 2 of 2024, with the completion of the development of the balance of Phase 1 anticipated in 2024 and 2025. Development of Phase 2 is targeted to commence in 2024 and to achieve completion by 2028 (from with score 0.7610742449760437).

In some embodiments, the anti-hallucination and attribution module 110 can visually mark-up (e.g., highlight, color-code) the attributed response. For example, the color yellow may be used highlight chunks (e.g., sentences) that have a relatively low similarity score (e.g., relative to a threshold value). The color red may be used to highlight chunks for which no relevant passages were located by the anti-hallucination and attribution retriever 114. The color green may be used to highlight chunks that have a relatively high similarity score (e.g., relative to the threshold value) indicating that chunk was not generated by any hallucinations of the generative artificial intelligence model 108.

In another example, an original response generated by the generative artificial intelligence model 108 can include:
No, you do not need to pay federal tax and state tax for interest earned on the 2023 Series A Bonds, as they are not excluded from gross income for federal income tax purposes and are not included in gross income under the existing Gross Income Tax Act. However, it is recommended to consult with a tax professional for further guidance.

The corresponding attributed response generated by the anti-hallucination and attribution module 110 can include the following:
No, you do not need to pay federal tax and state tax for interest earned on the 2023 Series A Bonds, as they are not excluded from gross income for federal income tax purposes and are not included in gross income under the existing Gross Income Tax Act (from with score 0.7880104780197144). However, it is recommended to consult with a tax professional for further guidance (from with score 0.4502568244934082).

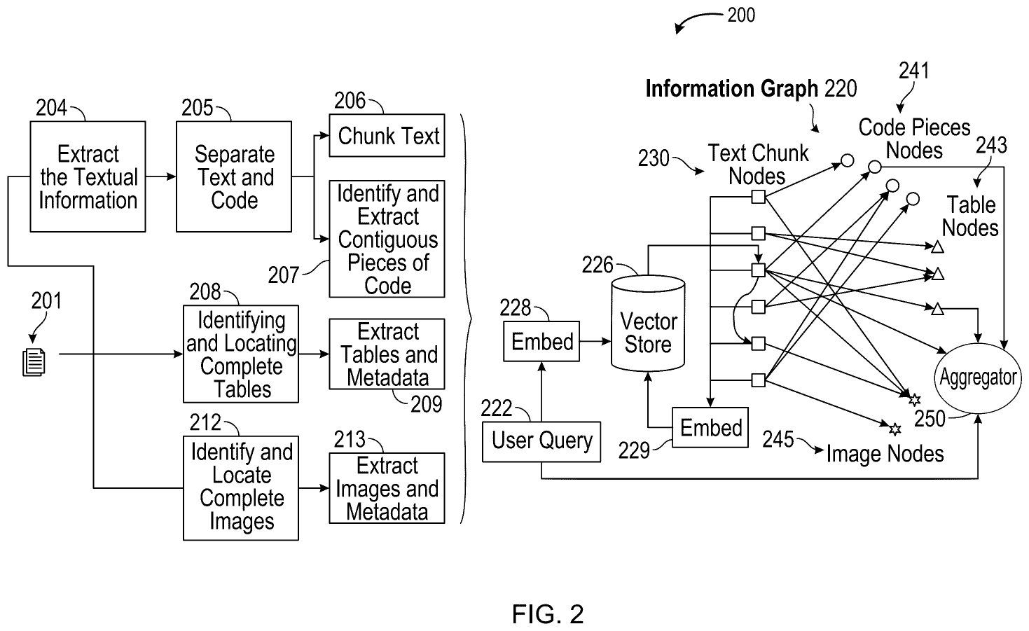

FIG. 2 depicts a diagram 200 of an example parsing and information graph generation process for enterprise generative artificial intelligence system using an anti-hallucination and attribution architecture according to some embodiments. The example data record preprocessing and information retrieval process may be performed by one or more of the systems and/or subsystems described herein (e.g., enterprise generative artificial intelligence system 802). The information graph may be used to facilitate information retrieval in order to accurately attribute source passages to chunks of a response and prevent hallucination.

Generally, data records can include different modalities of information, such as pure text, tables, images, code, video, audio, and the like. In order to effectively and reliably retrieve information for a query, the preprocessing and information retrieval process provides a multimodal approach for extracting information from the data records.

The preprocessing and information retrieval process may include three stages. The first stage may include parsing and extracting different modalities from these documents. This process can be done in parallel (or substantially in parallel) for all different modalities.

In one example, text and code can be parsed (step 202). Depending on the file format, extracting textual information, that is pure text and code, can come with different difficulties and may require leveraging different libraries. Irrespective of the data record type, the process can go through various steps to prepare for other downstream stages. Depending on the file format, some of these steps may increase in complexity.

One of these steps can include extracting textual information (step 204) from data records 201 so that they can be further parsed. For example, extracting everything that is not an image or table. The output of this step can include (e.g., may be required to include) all the textual information (e.g., information that are not image and table captions) from the data records, which can then be used for further separating text and code pieces. The parsed results may have a high fidelity (e.g., no introduction of random spaces, weird characters that would break the meaning of sentences), and robust to font, size, colors, location with respect to other elements of the pages).

Another step can include separating text and code (step 205). The goal of this step is to identify and separate code and pure text. This then allows the system to further process these modalities separately. An additional step can include chunking and parsing text and code (step 206). Having separated the text and code modalities, the purpose of this step is to identify, locate and extract contiguous pieces of code (step 207), and conduct chunking of the text contents (step 206) in reasonable and as contiguous fashion (e.g., that is no cutting mid-sentence or mid-paragraph especially due to breakages between pages and if possible, having chunks with contiguous topics).

The system (e.g., enterprise generative artificial intelligence system 802) may use an object-oriented structure, where there may be classes for pure text and code. These classes, at a minimum, can have fields keeping track of the content, location in the document, number of tokens of the content (e.g., that means that the system should have knowledge of the tokenizer for this purpose). For the text class, the system may already be able to keep track of what code snippets have been removed from the chunk's content (or are related to it). This may have already been done as part of the system.

In another example, tables can be parsed. An important modality in data records is tables. To be able to conduct effective information retrieval, the system can first locate and identify tables in full (e.g., since tables may span multiple pages/data records/segments or may appear in different structures in a single page). See step 206. The system can identify libraries that enable these features and measure their performance in identifying tables in full. Once the tables are identified, the tables may be extracted as an image or as a dataframe, and the like (step 209). The system can also extract the caption or title of the table, column headers, potentially also the row index(es), etc., as metadata associated with it (step 209). Similar to text and code classes, the system can also have a table class that keeps track of the extracted table content, its location, title/caption, etc.

In another example, images can be parsed. Similar to how the system handles tables, the system can also start with identifying and locating images in full (step 212). The system can include an image class to keep track of the images in the documents, that is the content, the location of the image in the doc and its caption/title as metadata associated with it. The system can also extract images as metadata associated with it (step 213).

At the end of the first stage, the system can have several instances of the text, code, table and image classes, outlining different modalities in each data record. Having done this, the system can continue to the second stage, namely, building an information graph for each data record.

In the second stage, in order to facilitate an effective information retrieval, the system can represent the information in each data record 201 by generating and/or using an information graph 220. The nodes 230, 241, 243 and 245 of this graph correspond to different instances of the four classes of modality from stage one. The depiction is a (directed) bipartite graph, with edges going out from the text nodes to all other modality nodes. Establishing these edges are the primary goal of this stage.

In the example of FIG. 2, there is an edge between a text node 230 to other modality nodes 241, 243, and/or 245, if there is reference (e.g., relation) between them. This can be established based on direct references to them in the text chunk, based on proximity or even based on contextual similarity with their caption or title. Having identified the edges, the system can keep track of what edges are between each text node 230 and other modality nodes 241, 243, and/or 245 as part of the text class. Once the system has fully specified this graph, the system can design an information retrieval process leveraging this graph 220. For example, agents (e.g., agents 906) and tools (e.g., tools 908) can use the graph to retrieve information. In another example, the anti-hallucination and attribution module 110 can use the graph 220 to attribute sources to a response to generate an attributed response. To this end, the information graph 220 may also include access control protocol information (e.g., as defined by the enterprise access control layer 515 and/or enterprise access control module 918).

In the third stage, given the information graph 220, the system can outline a process for information retrieval. One approach for this starts with first embedding the content of the text nodes (and/or other textual metadata associated with other modalities) (step 229) and storing the embeddings in a vector store 226. Given a query 222, the system can embed it (step 228) and find the most relevant text chunks or text nodes 230 associated with it. This would be the entry to the graph. At that point, the system can follow the out-going edges to other modality nodes. The classes associated with these modalities, (e.g., code, image, and table) may have a method that enables generation of relevant insights given the query. This method can be powered by different approaches, including multimodal models or other tools for understanding and querying the specific modalities. These insights, together with the text chunks and the query can then be combined in an aggregator 250 to a body of text or a prompt to be used for querying a model (e.g., multimodal model, large language model, etc.).

In one implementation, the functionality shown and described in FIG. 2 can be performed by a chunking module (e.g., chunking module 910) and/or embeddings generator module (e.g., embeddings generator module 912). For example, steps 204-213 may be performed by the chunking module, and the step 228-229 may be performed by the embeddings generator module. In some embodiments, the aggregator 250 comprises a portion of an orchestrator module (e.g., orchestrator module 904) and/or comprehension module (e.g., comprehension module 916).

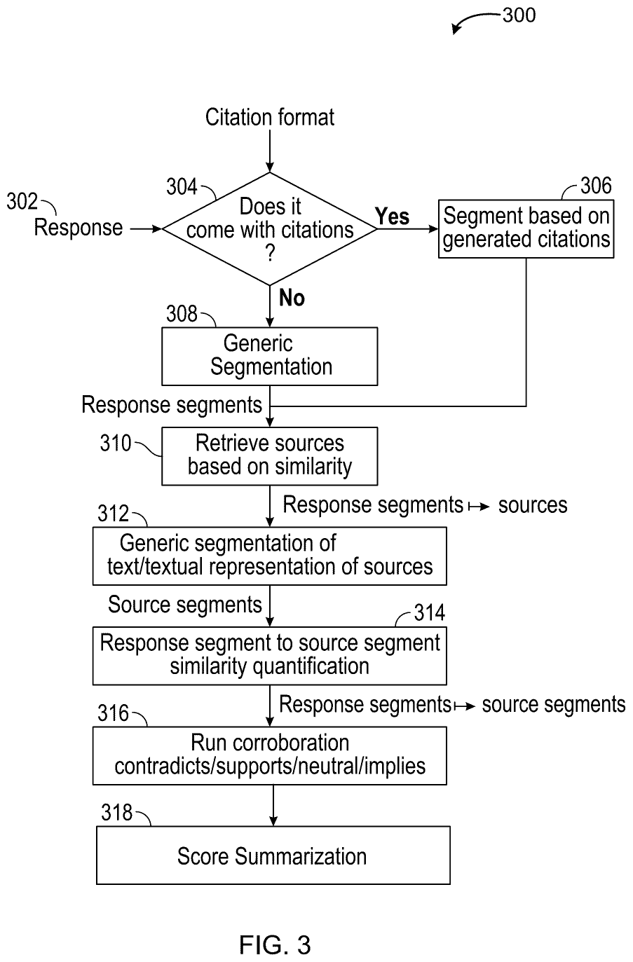

FIG. 3 depicts a flowchart 300 of an example anti-hallucination and attribution process for enterprise generative artificial intelligence systems. Generally, the anti-hallucination and attribution process (e.g., performed by an anti-hallucination and attribution module 110) is a fully standalone process (and module) that can be used to validate and corroborate any response (e.g., a response from a generative artificial intelligence model or a human generated response), regardless of whether it comes with inline citations or not.

In step 302, a response is received (e.g., from an enterprise generative artificial intelligence system, generative artificial intelligence model, human user, etc.). The response may be received by an anti-hallucination and attribution module (e.g., anti-hallucination and attribution module 110). In step 304, the anti-hallucination and attribution module determines whether the response already includes citations (e.g., provided by the generative artificial intelligence model of the enterprise generative artificial intelligence system during the response generation process). If the anti-hallucination and attribution module determines the response is associated with citations (e.g., inline citations), the segmentation of the response can be extracted by segmenting based on the available citations (step 306). If the anti-hallucination and attribution module determines that citations are not present in the response, the anti-hallucination and attribution module performs generic segmentation (step 308). More specifically, the generic segmentation is generally conducted based on the number of tokens and based on the sentences in the response. More specifically, for each segment, the anti-hallucination and attribution module can fit in as many sentences in the segment until it hits a segment maximum token limit.

In step 310, the anti-hallucination and attribution module assigns a set of sources based on a relevancy or similarity search. The anti-hallucination and attribution module can filter the source passages (or, sources) based on the resulting scores. The filtering may compare the resulting scores with one or more threshold values. For example, if a score is at or above the threshold value, then the associated source passages may be attributed to the segment. In another example, if a score is below the threshold value, then the associated source passage is not attributed to the segment. The similarity search can be an extension of a similarity score (e.g., “classical” cosine) and/or a function that can be over-written by an end-user.

The anti-hallucination and attribution module uses a mapping between the response segments and the sources with the relevancy score. The anti-hallucination and attribution module can also quantify/extract a credibility score associated with each source. The anti-hallucination and attribution module can then conduct a segmentation of the sources (step 312). More specifically, the anti-hallucination and attribution module can use the same segmentation logic used for segmenting the response. The anti-hallucination and attribution module computes the pairwise relevancy/similarity score among the response and source segments (step 314).

In step 316, the anti-hallucination and attribution module further enhances this mapping with a corroboration score/label associated with each pair, within the four categories of contradiction, supporting, neutral and implication. These can then be used to further prune key and values in this mapping. The supporting label can be added to potentially cover for shortcomings associated with generic segmentation.

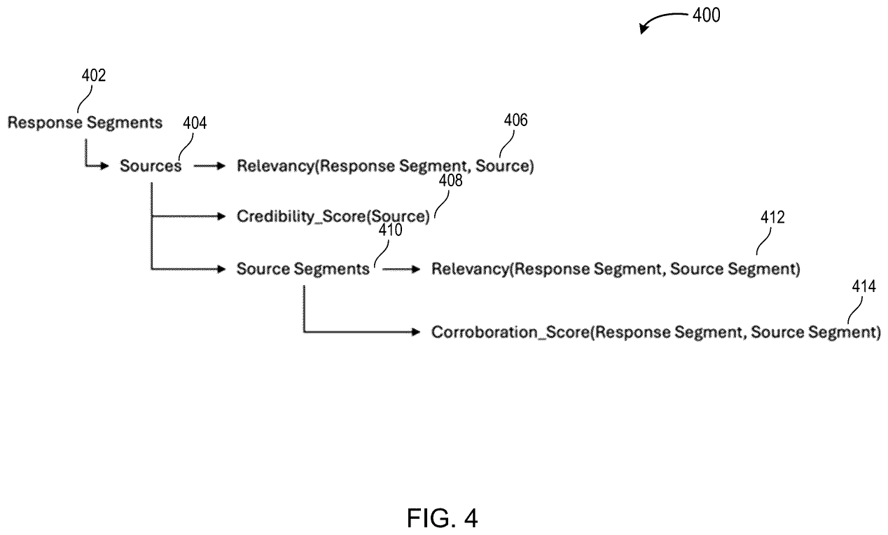

At this point, the anti-hallucination and attribution module has generated and quantified the relationship among the response and source segments. This is illustrated in FIG. 4 which shows all the different scores that define the relationships among the response and source segments. These can in turn be used to quantify a singular score associated with each response segment (e.g., quantifying its groundedness in sources) and a singular score associated with each source segment (e.g., in the context of the corresponding response segment). See step 318. In some embodiments, this process can accommodate user-defined heuristics for computing some or all of these scores and for computing the source credibility score based on the available metadata of the source, either during inference or upon ingestion of the sources.

FIG. 4 depicts a diagram 400 of an example structure of response segments generated by an anti-hallucination and attribution method for enterprise generative artificial intelligence systems according to some embodiments. More specifically, FIG. 4 includes response segments 402, sources, 404, relevancy scores 406 for the sources 404, credibility scores 408, sources segments 410, relevancy scores for sources segments 412, and corroboration scores 414.

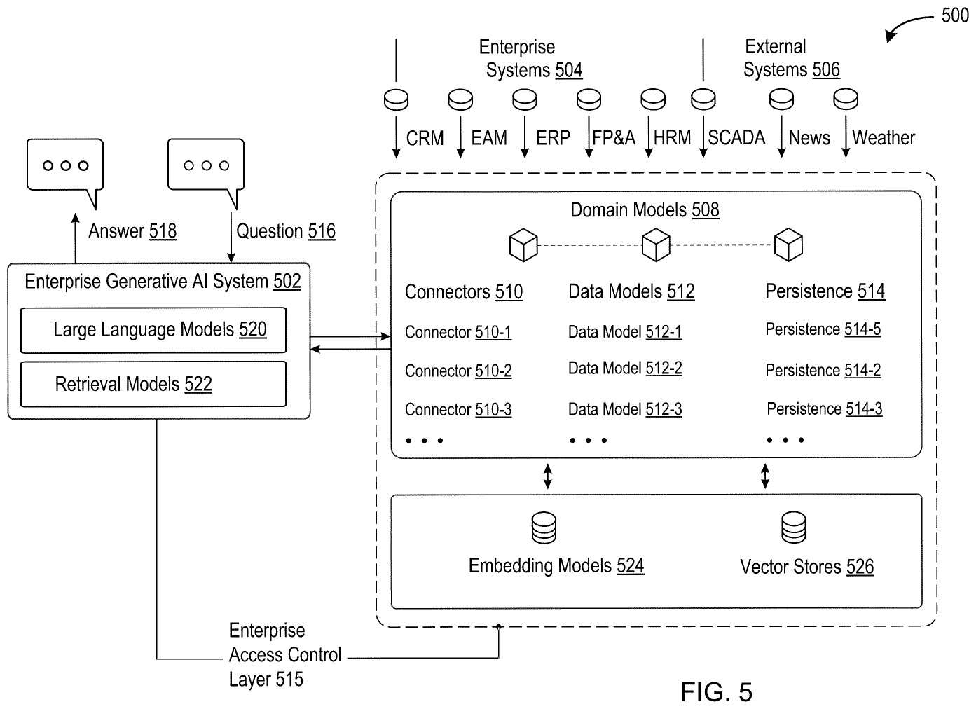

FIG. 5 depicts a diagram of an example enterprise generative artificial intelligence system architecture and environment 500 according to some embodiments. In the example of FIG. 5, the system architecture and environment 500 includes an enterprise generative artificial intelligence system 502, enterprise systems 504, external systems 506, domain models 508, a vector datastore 526, an embeddings models datastore 524, and an enterprise access control layer 515. In some embodiments, the query comprises a natural language query received through a graphical user interface. In some embodiments, the one or more enterprise data sets include any of documents, document segments, and insights generated by the one or more artificial intelligence applications. In some embodiments, each of the relevance scores is associated with a respective portion of the one or more enterprise data sets, and wherein each of the relevance scores are determined relative to the other respective portions of the one or more enterprise data sets.

Each data model of the plurality of data models can correspond to a different data domain of the plurality of different data domains. In some embodiments, each data model represents respective relationships and attributes of the corresponding different data domain of the plurality of different data domains. The respective relationships and attributes include any of data types, data formats, and industry-specific information. In some embodiments, the natural language output comprises a summary of at least one of the respective portions of the one or more enterprise data sets associated with a relevance score.

Generally, the enterprise generative artificial intelligence system 502 can function to securely query and process enterprise data and applications across different domains of an enterprise information environment. This can be referred to as a generative enterprise search (or, simply, enterprise search). As shown, the enterprise generative artificial intelligence system 502 can receive a question 516 (e.g., input, a prompt, a natural language query, instruction, etc.). Generally, the enterprise generative artificial intelligence system 502 can process the query using large language models 520 and retrieval models 522. More specifically, the enterprise generative artificial intelligence system 502 can use the large language models 520 to interpret, understand and/or parse queries. The retrieval models 522 can interact with the large language models 520 and the domain models 508 to retrieve data records (e.g., documents, images, application outputs, artificial intelligence insights, objects, and the like) across different domains using data models 512 specific to each domain. Accordingly, the enterprise generative artificial intelligence system 502 can use the large language models 520, retrieval models 522, and the domain models 508 to generate an enterprise search result that is accurate, reliable, and secure.

The enterprise generative artificial intelligence system 502 can facilitate ingestion and persistence of enterprise system data from the enterprise systems 504 and/or external system data from the external systems 506 (e.g., systems outside of the enterprise information environment) using connectors 510, data models 512, and various persistent storage mechanisms and techniques 514. The enterprise systems 504 can include CRM systems, EAM systems, ERP systems, and or the like, and the connectors can facilitate data ingestion from disparate data sources (e.g., Oracle systems, SAP systems, and/or the like). In some embodiments, the data models 512 provide attributes, relationships, and/or functions associated with a particular domain. For example, domains can include aerospace domains 512-1, energy domains 512-2, defense domains 512-3, and/or the like. The domain models 508 can enable the enterprise generative artificial intelligence system 502 to provide domain-specific results without comprising the security or the integrity of the underlying enterprise data, systems, and applications.

Furthermore, the enterprise generative artificial intelligence system 502 utilizes or manages an enterprise access control layer 515, which can provide numerous technological benefits. In some embodiments, the enterprise access control layer 515 facilitates the separation of underlying enterprise information (e.g., enterprise data, applications, systems) from the large language models 520 and/or other machine learning models of the enterprise generative artificial intelligence system 502. Accordingly, the enterprise generative artificial intelligence system 502 can provide domain-specific deterministic results without having to train the large language models 520 and/or other machine learning models on such enterprise information which can cause the myriad of problems discussed above (e.g., information leakage, hallucination).

In some embodiments, the enterprise generative artificial intelligence system 502 can use the enterprise access control layer 515 to implement additional enterprise controls. For example, an enterprise information environment may include users and systems with different enterprise permission levels. The enterprise access control layer 515 can ensure that responses or output comply with access and security protocol. The enterprise generative artificial intelligence system 502 protects information so that a user is permitted to access based on permissions, profiles, and controls. In one example, the enterprise access control layer 515 can filter information that is restricted by the retrieval model 522, prior to processing by the large language models 520, or presenting the answer or other output. More specifically, the enterprise access control layer 515 may filter data sources, data records, and/or other elements of an enterprise information environment such that query responses (or supporting traceability references) do not include information the user is not permitted to access.

The enterprise generative artificial intelligence system can also perform similar functionality based on the context of users and/or systems submitting the query. For example, a director and engineer may submit the same query (e.g., “what projects are past due?”), and the enterprise generative artificial intelligence system 502 can use contextual information (e.g., user role, permissions, domain associated with the user, and the like) to provide a response that is based on context both substantively (e.g., provide information on overdue projects for the particular requester) and/or with respect presentation of the response (e.g., an engineer may receive more detailed technical information while a director may receive fewer technical details).

In some embodiments, the enterprise generative artificial intelligence system 502 can crawl, index, and/or map a corpus of data records (e.g., data records of one or more enterprise systems or environments) using contextual information (e.g., contextual metadata) along with data record embeddings to provide access control (e.g., role-based access), improved data record identification and retrieval, and map relationships between data records. In one example, contextual information may prevent some users from accessing (e.g., viewing, retrieving) certain data records, and improve similarity evaluations used in retrieval operation (e.g., of a generative artificial intelligence process).

In some implementations, the enterprise generative artificial intelligence system 502 can generate embeddings based on the embedding models of the embedding models datastore 524 and the content of the data records. In some implementations, the embeddings may be represented by one or more vectors that can be stored in the vector datastore 526. In some implementations, the retrieval models 522 can use the embeddings to retrieve relevant data records and perform similarity or relevance evaluations or other aspects of retrieval operations. As used herein, data records can include unstructured data records (e.g., documents and text data that is stored on a file system in a format such as PDF, DOCX, MD, HTML, TXT, PPTX, image files, audio files, video files, application outputs, and the like), structured data records (e.g., database tables or other data records stored according to a data model or type system), timeseries data records (e.g., sensor data, artificial intelligence application insights), and/or other types of data records (e.g., access control lists).

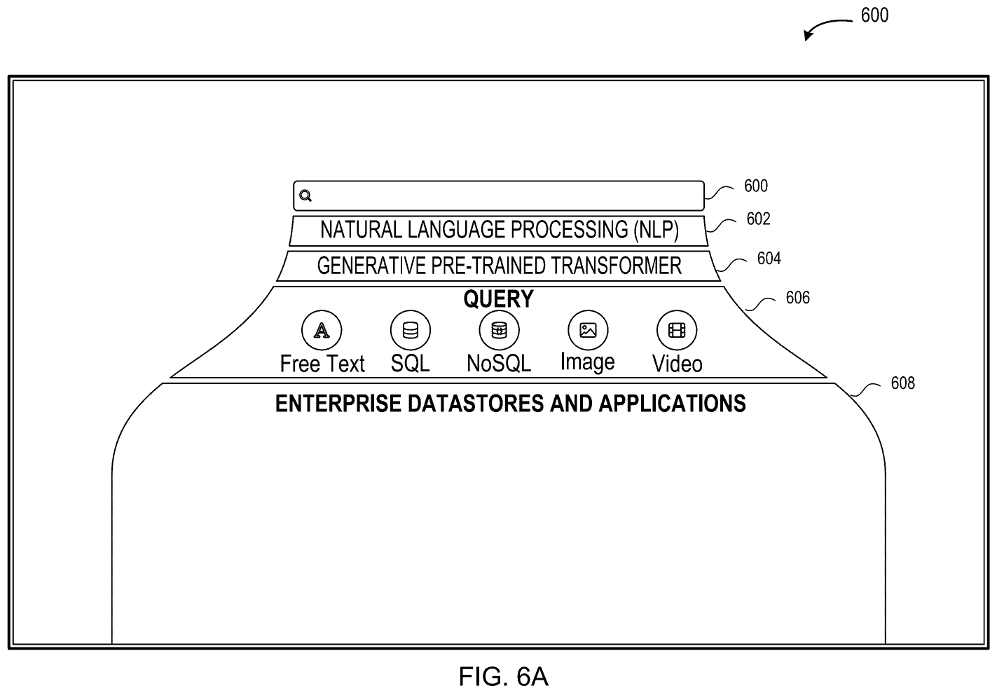

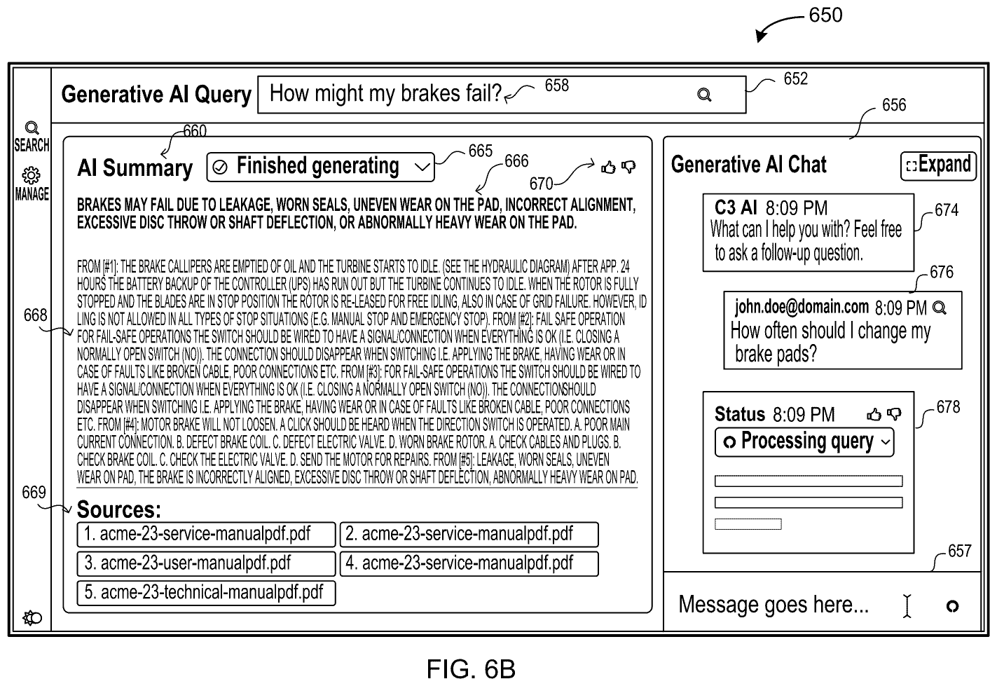

FIG. 6A depicts an example enterprise search graphical user interface 600 and underlying architecture 602-608 according to some embodiments. Generally, the graphical user interfaces depicted in FIG. 6A and FIG. 6B include a human computer interface for receiving natural language queries and presenting relevant information from the enterprise information environment in response to the queries. Although not shown in FIG. 6A or 6B, the relevant information can also include visualizations, predictive analysis, control commands, and/or other information obtained or generated by enterprise generative artificial intelligence systems.

In the example of FIG. 6A, the diagram includes an enterprise query input interface 600 and framework 602-608 for unifying information access methodologies and application operations across legacy and new enterprise applications and a growing magnitude of data sources in various enterprise environments. The enterprise generative artificial intelligence systems described herein can harmonize access to information and increase availability to complex application operations while respecting enterprise security and privacy controls. This framework uses machine learning techniques (e.g., generative artificial intelligence algorithms and models) to navigate enterprise information and applications, comprehend organization specific context queues (e.g., acronyms, nicknames, jargon, and the like), and locate information most relevant to a request (e.g., query, question, prompt, etc.). This can, for example, lower the learning curve and reduce the steps a user must perform to access information, thereby democratizing usage of information currently blocked by complexities and domain expertise required by conventional enterprise information systems.

In the example of FIG. 6A, the enterprise query input interface 600 comprises a graphical user interface element configured to receive various inputs, such as a natural language query. For example, a user may ask the system “How might my breaks fails?” and an enterprise generative artificial intelligence system can process the query with a natural language processing component 602 and one or more generative pre-trained transformers 604 (e.g., large language models and/or other machine learning models) to generate an answer securely, accurately, and reliably based on a variety of disparate enterprise datastores and applications 608. More specifically, the natural language processing component 602 and the generative pre-trained transformers 604 can generate one or more new queries 606 in order to process the initial user query. For example, a first new query may comprise an SQL query to retrieve data records from relational database management systems, the second query may comprise another type of query (e.g., an instruction set) to execute one or more applications such that the result of that application execution can be returned and used by the system to generate the enterprise search response. An example enterprise search response interface is shown in FIG. 6 and described below.

In some embodiments, the enterprise search interfaces shown and described in FIGS. 6A and 6B can be generated by the enterprise generative artificial intelligence systems described herein, and the framework 602-608 can represent the enterprise generative artificial intelligence system architectures and environments described herein.

FIG. 6B depicts an example enterprise generative artificial intelligence response graphical user interface 650 according to some embodiments. In some embodiments, the enterprise generative artificial intelligence response graphical user interface 650 can be generated at least in part by the enterprise generative artificial intelligence systems described herein. In the example of FIG. 6B, the enterprise generative artificial intelligence response graphical user interface 650 includes an enterprise search query input portion 652, a generative enterprise search result portion 654, and an interactive query portion 656.

The enterprise search query input portion 652 presents an enterprise search query 658. In some implementations, the query can be input through the input portion 652, although it may also have been input in another interface (e.g., interface 600 shown in FIG. 6A) and presented in the input portion 652 as part of the generative enterprise search response.

The generative enterprise search result portion 654 includes a type of generative artificial intelligence response 660, a generative artificial intelligence response status 662, a generative artificial intelligence enterprise search result 666, source data portions 668 that were used the generate the response, source identifications 669, and generative artificial intelligence response feedback elements 670. In the example of FIG. 6B, the response type 660 is a summary, although there may be other response types that enterprise generative artificial intelligence systems can generate. The response status indicates the status of the response. Responses statuses can include, for example, processing query, processed query, evaluated metric, searched documents, generated answer (e.g., result), generated visualization (e.g., a time series visualization for presentation in a response graphical user interface), and/or finished generating (e.g., as shown in FIG. 6B).

The source data portions 668 include at least a portion of the information from the source data used to generate the response. This can, for example, enable the response to be confirmed without having to independently verify the response. The source identifications 669 identify the source data records used to generate the response. For example, the source identifications can indicate an entity name, a domain type, a description or name of the data record (e.g., service manual, user manual, technical manual, and/or the like), and/or a type of data record (e.g., a document, or, more specifically, a PDF document), and/or the like. This can also provide traceability and enable the user to trust the response.

The response feedback portion 670 enables users to provide feedback regarding the response (e.g., positive or negative feedback). Enterprise generative artificial intelligence systems can, for example, use the received feedback to improve enterprise generative artificial intelligence systems (e.g., through reinforcement learning).

The interactive query portion 656 enables users to input additional related queries (e.g., “follow-up” questions) through an interactive input portion 657. In the example of the FIG. 6B, the interactive query portion 656 comprises a chat interface, although other interfaces may use different interactive query portions. The interactive query portion 656 also includes a system generated message 674 prompting the user to ask follow-up questions, and users can provide additional related queries 676. The interactive query portion 656 can also include a status portion 678 indicating a process status of the additional related query 676. The status can include, for example, processing query (e.g., as shown in FIG. 6B), processed query, evaluated metric, searched documents, generated answer (e.g., result), generated visualization (e.g., a time series visualization for presentation in a response graphical user interface), and/or finished generating.

Time series refers to a list of data points in time order that can represent the change in value over time of data relevant to a particular problem, such as inventory levels, equipment temperature, financial values, or customer transactions. Time series provide the historical information that can be analyzed by generative and machine-learning algorithms to generate and test predictive models. Example implementations apply cleansing, normalization, aggregation, and combination, time series data to represent the state of a process over time to identify patterns and correlations that can be used to create and evaluate predictions that can be applied to future behavior.

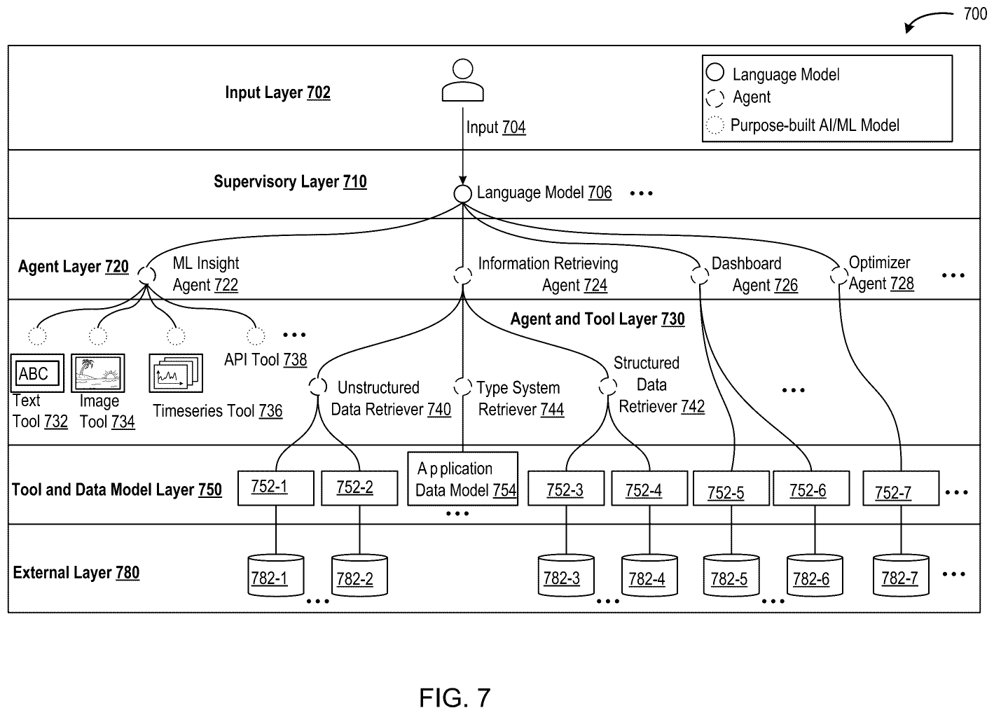

FIG. 7 depicts a diagram 700 of an example layered architecture and environment of an enterprise generative artificial intelligence system (e.g., enterprise generative artificial intelligence system 802) according to some embodiments. In the example of FIG. 7, the enterprise generative artificial intelligence system architecture and environment includes a hierarchy of layers. More specifically, the hierarchy of layers includes an input layer 702, a supervisory layer 710, an agent layer 720, an agent and tool layer 730, a tool and data model layer 750, and an external layer 780. It will be appreciated that these layers are shown by way of example, and other examples can include any number of such layers (e.g., any number of layers 720 and 730).

The input layer 702 represents a layer of the enterprise generative artificial intelligence system architecture that receives an input (e.g., a query, complex input, instruction set, and/or the like) from a user or system. For example, an interface module of the enterprise generative artificial intelligence system may receive the input.

The supervisory layer 710 represents a layer of the enterprise generative artificial intelligence system architecture that includes one or more large language models (e.g., of an orchestrator module) that can develop a plan for responding to the input received in the input layer 702. A plan can include a set of prescribed tasks (e.g., retrieval tasks, API call tasks, and the like). In one example, the supervisory layer 710 can provide pre-processing and post-processing functionality described herein as well as the functionality of the orchestrators and comprehension modules described herein. The supervisory layer 710 can coordinate with one or more of the subsequent layers 720-780 to execute the prescribed set of tasks.

The agent layer 720 represents a layer of the enterprise generative artificial intelligence system architecture that includes agents that can execute the prescribed set of tasks. In the example of FIG. 7, the agent layer 720 includes a machine learning insight agent 722, an information retrieving agent 724, a dashboard agent 726, and an optimizer agent 728. Each of the agents 724-728 can include a large language model that provides reasoning functionality for accomplishing their assigned portion of the prescribed set of tasks. More specially, the agents 724-728 can instruct the agents and tools of subsequent layers (e.g., layer 730), of which there could be any number, to execute the tasks. For example, the machine learning insight agent 722 can instruct the text processing tool 732 to perform a text processing task (e.g., transform an artificial intelligence application output into natural language), an image processing tool 734 to perform an image processing task (e.g., generate a natural language summary of an image outputted from artificial intelligence application), a timeseries tool 736 to obtain summarize timeseries data (e.g., timeseries data output from an artificial intelligence application), and an API tool 738 to perform an API call task (e.g., execute an API call to trigger or access an artificial intelligence application).

The information retrieving agent 724 may cooperate with, and/or coordinate, several different agents to perform retrieval tasks. For example, the information retrieving agent 724 may instruct an unstructured data retriever agent 740 to receive unstructured data records, a structured data retriever agent 742 to retrieve structured data records, and a type system retriever agent 744 to obtain one or more data models (or subsets of data models) and/or types from a type system. The type system provides compatibility across different data formats, protocols, operating languages, disparate systems, etc. Types can encapsulate data formats for some or all of the different types or modalities described herein (e.g., multimodal, text, coded, language, statistical, audio, visual, audiovisual, etc.). For example, a data model may include a variety of different types (e.g., in a tree or graph structure), and each of the types may describe data fields, operations, functions, and the like. Each type can represent a different object (e.g., a real-world object, such as a machine or sensor in a factory) or system (e.g., computing cluster, enterprise datastores, file systems), and each type can include a large language model context that provides context for the large language model to design or update a plan. For example, the context may include a natural language summary or description of the type (e.g., a description of the represented object, relationships with other types or objects, associated methods and functions, and the like). Types can be defined in a natural language format for efficient processing by large language models. The type system retriever agent 744 may traverse the data model 754 to retrieve a subset of the data model 754 and/or types of the data model 754. The structured data retriever agent 742 can then use that retrieved information to efficiently retrieve structured data from a structured data source (e.g., a structured data source that is structured or modeled according to the data model 754).

The dashboard agent 726 may be configured to generate one or more visualizations and/or graphical user interfaces, such as dashboards. For example, the dashboard agent 726 may execute tools 752-5 and 752-6 to generate dashboards based on information retrieved by the other agents and/or information output by the other agents (e.g., natural language summaries of associated tool outputs).

The optimizer agent 728 may be configured to execute a variety of different prescriptive analytics functions and mathematical optimizations 752-7 to assist in the calculation of answers for various problems. For example, the large language model 706 may use the optimizer agent 728 to generate plans, determine a set of prescribed tasks, determine whether more information is needed to generate a final result, and the like.

The tool and data model layer 750 is intended to represent a layer of the enterprise generative artificial intelligence system architecture that includes tools 752 and the data model 754. The agents 740-742 can execute the tools 752 to retrieve information from various applications and datastores 782 in the external layer 780 (e.g., external relative to the enterprise generative artificial intelligence system). The tools 252 may include connectors that can connect to systems and datastore that are external to the enterprise generative artificial intelligence system.

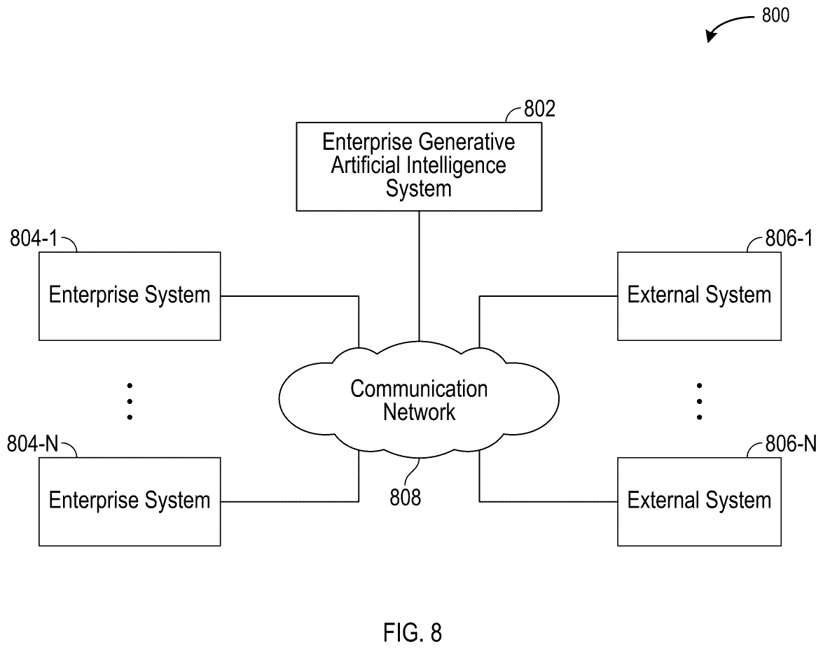

FIG. 8 depicts a diagram 800 of an example network system for enterprise generative artificial intelligence according to some embodiments. In the example of FIG. 8, the network system includes an enterprise generative artificial intelligence system 802, enterprise systems 804-1 to 804-N (individually, the enterprise system 804, collectively, the enterprise systems 804), external systems 806-1 to 806-N (individually, the external system 806, collectively, the external systems 806), and a communication network 808.

The enterprise generative artificial intelligence system 802 may function to iteratively and non-iteratively generate machine learning model inputs and outputs to determine a final output (e.g., “answer” or “result”) in response to an initial input (e.g., provided by a user or another system). In some embodiments, functionality of the enterprise generative artificial intelligence system 802 may be performed by one or more servers (e.g., a cloud-based server) and/or other computing devices. The enterprise generative artificial intelligence system 802 may be implemented using a type system and/or model-driven architecture. The enterprise generative artificial intelligence system 802 may also include the anti-hallucination and attribution module 110 (e.g., added to the enterprise generative artificial intelligence system 802, and/or connected to the enterprise generative artificial intelligence system 802, after the enterprise generative artificial intelligence system 802 has been deployed).

In various implementations, the enterprise generative artificial intelligence system 802 can provide a variety of different technical features, such as effectively handling and generating complex natural language inputs and outputs, generating synthetic data (e.g., supplementing customer data obtained during an onboarding process, or otherwise filling data gaps), generating source code (e.g., application development), generating applications (e.g., artificial intelligence applications), providing cross-domain functionality, as well as a myriad of other technical features that are not provided by traditional systems. As used herein, synthetic data can refer to content generated on-the-fly (e.g., by large language models) as part of the processes described herein. Synthetic data can also include non-retrieved ephemeral content (e.g., temporary data that does not subsist in a database), as well as combinations of retrieved information, queried information, model outputs, and/or the like.

In some embodiments, the enterprise generative artificial intelligence system 802 can provide and/or enable an intuitive non-complex interface to rapidly execute complex user requests with improved access, privacy, and security enforcement. The enterprise generative artificial intelligence system 802 can include a human computer interface for receiving natural language queries and presenting relevant information with predictive analysis from the enterprise information environment in response to the queries. For example, the enterprise generative artificial intelligence system 802 can understand the language, intent, and/or context of a user natural language query. The enterprise generative artificial intelligence system 802 can execute the user natural language query to discern relevant information from an enterprise information environment to present to the human computer interface (e.g., in the form of an “answer”).

In some embodiments, generative artificial intelligence models (e.g., large language models of an orchestrator) of the enterprise generative artificial intelligence system 802 can interact with agents (e.g., retrieval agents, retriever agents) to retrieve and process information from various data sources. For example, data sources can store data records and/or segments of data records which may be identified by the enterprise generative artificial intelligence system 802 based on embedding values (e.g., vector values associated with data records and/or segments). Data records can include tables, text, images, audio, video, code, application outputs (e.g., predictive analysis and/or other insights generated by artificial intelligence applications), and/or the like.

In some embodiments, the enterprise generative artificial intelligence system 802 can generate context-based synthetic output based on retrieved information from one or more retriever models. For example, retriever models (e.g., retriever models or a retrieval agent) can provide additional retrieved information to the large language models to generate additional context-based synthetic output until context validation criteria is satisfied. Once the validation criteria are satisfied, the enterprise generative artificial intelligence system 802 can output the additional context-based synthetic output as a result or instruction set (collectively, “answers”). The context validation criteria may include a threshold for identifying source material from an enterprise data system that corroborate the response.

In various embodiments, the enterprise generative artificial intelligence system 802 provides transformative context-based intelligent generative results. For example, the enterprise generative artificial intelligence system 802 can process inputs from enterprise users using a natural language interface to rapidly locate, retrieve, and present relevant data across the entire corpus of an enterprise's information systems.

As discussed elsewhere herein, the enterprise generative artificial intelligence system 802 can handle both machine-readable inputs (e.g., compiled code, structured data, and/or other types of formats that can be processed by a computer) and human-readable inputs. Inputs can also include complex inputs, such as inputs including “and,” “or”, inputs that include different types of information to satisfy the input (e.g., data records, text documents, database tables, and artificial intelligence insights), and/or the like. In one example, a complex input may be “How many different engineers has John Doc worked with within his engineering department?” This may require the enterprise generative artificial intelligence system 802 to identify John Doe in a first iteration, identify John Doe's department in a second iteration, determine the engineers in that department in a third iteration, then determine in a fourth iteration which of those engineers John Doc has interacted with, and then finally combine those results, or portions thereof, to generate the final answer to the query. More specifically, the enterprise generative artificial intelligence system 802 can use portions of the results of each iteration to generate contextual information (or, simply, context) which can then inform the subsequent iterations.

The enterprise systems 804 can include enterprise applications (e.g., artificial intelligence applications), enterprise datastores, client systems, and/or other systems of an enterprise information environment. As used herein, an enterprise information environment can include one or more networks (e.g., cloud, on premise, air-gapped or otherwise) of enterprise systems (e.g., enterprise applications, enterprise datastores), client systems (e.g., computing systems for access enterprise systems). The enterprise systems 804 can include disparate computing systems, applications, and/or datastores, along with enterprise-specific requirements and/or features. For example, enterprise systems 804 can include access and privacy controls. For example, a private network of an organization may comprise an enterprise information environment that includes various enterprise systems 804. Enterprise systems 804 can include, for example, CRM systems, EAM systems, ERP systems, FP&A systems, HRM systems, and SCADA systems. Enterprise systems 804 can include or leverage artificial intelligence applications and artificial intelligence applications may leverage enterprise systems and data. Enterprise systems 804 can include data flow and management of different processes (e.g., of one or more organizations) and can provide access to systems and users of the enterprise while preventing access from other systems and/or users. It will be appreciated that, in some embodiments, references to enterprise information environments can also include enterprise systems, and references to enterprise systems can also include enterprise information environments. In various embodiments, functionality of the enterprise systems 804 may be performed by one or more servers (e.g., a cloud-based server) and/or other computing devices.

The external systems 806 can include applications, datastores, and systems that are external to the enterprise information environment. In one example, the enterprise systems 804 may be a part of an enterprise information environment of an organization that cannot be accessed by users or systems outside that enterprise information environment and/or organization. Accordingly, the example external systems 806 may include Internet-based systems, such as news media systems, social media systems, and/or the like, that are outside the enterprise information environment. In various embodiments, functionality of the external systems 806 may be performed by one or more servers (e.g., a cloud-based server) and/or other computing devices.

The communications network 808 may represent one or more computer networks (e.g., LAN, WAN, air-gapped network, cloud-based network, and/or the like) or other transmission mediums. In some embodiments, the communication network 808 may provide communication between the systems, modules, engines, generators, layers, agents, tools, orchestrators, datastores, and/or other components described herein. In some embodiments, the communication network 808 includes one or more computing devices, routers, cables, buses, and/or other network topologies (e.g., mesh, and the like). In some embodiments, the communication network 808 may be wired and/or wireless. In various embodiments, the communication network 808 may include local area networks (LANs), wide area networks (WANs), the Internet, and/or one or more networks that may be public, private, IP-based, non-IP based, air-gapped, and so forth.

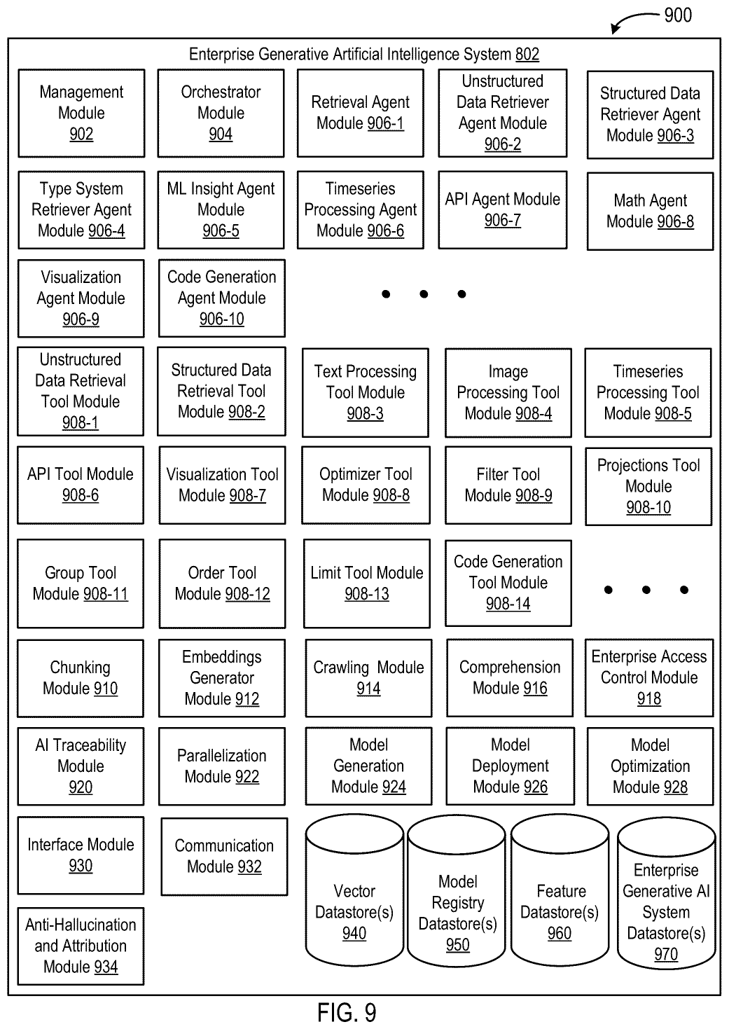

FIG. 9 depicts a diagram 900 of an example enterprise generative artificial intelligence system 802 according to some embodiments. In the example of FIG. 9, the enterprise generative artificial intelligence system 802 includes a management module 902, an orchestrator module 904, a retrieval agent module 906-1, an unstructured data retriever agent module, 906-2, a structured data retriever agent module 906-3, a type system retriever agent module 906-4, a machine learning insight module 906-5, a timeseries processing agent 906-6, an API agent module 906-7, a math agent module 906-8, a visualization agent module 906-9, a code generation agent module 906-10, an unstructured data retrieval tool 908-1, an structured data retrieval tool 908-2, a text processing tool module 908-3, an image processing tool module 908-4, a timeseries processing tool module 908-5, an API tool module 908-6, a visualization tool module 908-7, an optimizer tool module 908-8, a filter tool module 908-9, a projections tool module 908-10, a group tool module 908-11, an order tool module 908-12, a limit tool module 908-13, code generation tool module 908-14, a chunking module 910, an embeddings generator module 912, a crawling module 914, a comprehension module 916, an enterprise access control module 918, an artificial intelligence traceability module 920, a parallelization module 922, model generation module 924, a model deployment module 926, a model optimization module 928, an interface module 930, a communication module 932, an anti-hallucination and attribution module 934, vector datastore(s) 940, model registry datastore(s) 950, feature datastore(s) 960, and enterprise generative artificial intelligence system datastore(s) 970.

In some embodiments, the chunking module 910, embeddings generator module 912, crawling module 914, vector datastore 940 (e.g., that stores embeddings), and portions of the enterprise generative artificial intelligence system datastores 970 (e.g., a segment datastore) may comprise an intelligent crawling and chunking subsystem (e.g., the intelligent crawling and chunking subsystem 120).

The management module 902 can function to (e.g., create, read, update, delete, or otherwise access) data associated with the enterprise generative artificial intelligence system 802. The management module 902 can store or otherwise manage or store in any of the datastores 940-970, and/or in one or more other local and/or remote datastores. It will be appreciated that datastores can be a single datastore local to the enterprise generative artificial intelligence system 802 and/or multiple datastores remote to the enterprise generative artificial intelligence system 802. In some embodiments, the datastores described herein comprise one or more local and/or remote datastores. The management module 902 can perform operations manually (e.g., by a user interacting with a GUI) and/or automatically (e.g., triggered by one or more of the modules 904-930). Like other modules described herein, some or all the functionality of the management module 902 can be included in and/or cooperate with one or more other modules, systems, and/or datastores.

The orchestrator module 904 can function to generate and/or execute one or more orchestrator agents (or, simply, orchestrators). An orchestrator can orchestrate, supervise, and/or otherwise control agents 906. In some implementations, the orchestrator includes one or more large language models. The orchestrator can interpret inputs, select appropriate agents for handling queries and other inputs, and route the interpreted input to the selected agents. The orchestrator can also execute a variety of supervisory functions. For example, the orchestrator may implement stopping conditions to prevent the comprehension module from stalling in an endless loop during an iterative context-based generative artificial intelligence process. The orchestrator may also include one or more other types of models to process (e.g., transform) non-text input. Other models (e.g., other machine learning models, translation models) may also be included in addition to, or instead of, the large language models for some or all of the agents and/or modules described herein.

In some embodiments, an orchestrator can process data received from a variety of data sources in different formats that can be processed with natural language processing (NLP) (e.g., with tokenization, stemming, lemmatization, normalization, and the like) with vectorized data and can generate pre-trained transformers that are fine-tuned or re-trained on specific data tailored for an associated data domain or data application (e.g., SaaS applications, legacy enterprise applications, artificial intelligence application). Further processing can include data modeling feature inspection and/or machine learning model simulations to select one or more appropriate analysis channels. Example data objects can include accounts, products, employees, suppliers, opportunities, contracts, locations, digital portals, geolocation manufacturers, supervisory control and data acquisition (SCADA) information, open manufacturing system (OMS) information, inventories, supply chains, bills of materials, transportation services, maintenance logs, and service logs.

In some embodiments, the orchestrator module 904 can use a variety of components when needed to inventory or generate objects (e.g., components, functionality, data, and/or the like) using rich and descriptive metadata, to dynamically generate embeddings for developing knowledge across a wide range of data domains (e.g., documents, tabular data, insights derived from artificial intelligence applications, web content, or other data sources). In an example implementation, the orchestrator module 904 can leverage, for example, some or all of the components described herein. Accordingly, for example, the orchestrator module 904 can facilitate storage, transformation, and communication to facilitate processing and embedding data. In some implementations, the orchestrator module can create embeddings for multiple data types across multiple industry verticals and knowledge domains, and even specific enterprise knowledge. Knowledge may be modeled explicitly and/or learned by the orchestrator module 904, agents 906, and/or tools 908. In an example, the orchestrator module 904 (and/or chunking module 910) generates embeddings that are translated or transformed for compatibility with the comprehension module 916.

In some embodiments, the orchestrator 904 can be configured to make different data domains operate or interface with the components of the enterprise generative artificial intelligence system 802. In one example, the orchestrator module 904 may embedded objects from specific data domains as well as across data domains, applications, data models, analytical by-products, artificial intelligence predictions, and knowledge repositories to provide robust search functionality without requiring specialized programming for each different data domain or data source. For example, the orchestrator module 904 can create multiple embeddings for a single object (e.g., an object may be embedded in a domain-specific or application-specific context). In some embodiments, the chunking module 910 along with the orchestrator module 904 can curate the data domains for embedding objects of the data domains in the enterprise information systems and/or environments. In some embodiments, the orchestrator 904 can cooperate with the chunking module 910 to provide the embedding functionality described herein.

In some embodiments, the orchestrator module 904 can cause an agent 906 to perform data modeling to translate raw source data formats into target embeddings (e.g., objects, types, and/or the like). Data formats can include some or all of the different types or modalities described herein (e.g., multimodal, text, coded, language, statistical, audio, visual, audiovisual, etc.). In an example implementation, the orchestrator module 904, and/or the enterprise generative artificial intelligence system 802 generally, employs a type system of a model-driven architecture to perform data modeling to translate raw source data formats into target types. A knowledge base of the enterprise generative artificial intelligence system 802 and generative artificial intelligence models can create the ability to integrate or combine insights from different artificial intelligence applications.

As discussed elsewhere herein, the enterprise generative artificial intelligence system 802 can handle machine-readable inputs (e.g., compiled code, structured data, and/or other types of formats that can be processed by a computer) in addition to human-readable inputs. Inputs can also include complex inputs, such as inputs including “and,” “or”, inputs that include different types of information to satisfy the input (e.g., text documents, database tables, and artificial intelligence insights). The orchestrator 904 may break up these complex inputs (e.g., by using a large language model) to be handled by multiple agents 906 (e.g., in parallel).

As discussed above, the orchestrator module 904 can function to execute and/or otherwise process various supervisory functions. In some implementations, the orchestrator module 904 may enforce conditions (e.g., stopping conditions, resource allocation, prioritization, and/or the like). For example, a stopping condition may indicate a maximum number of iterations (or, hops) that can be performed before the iterative process terminates. The stopping condition, and/or other features managed by the orchestrator module 904, may be included in large language model prompts and/or in the large language models of the orchestrator and/or comprehension module 916, discussed below. In some embodiments, the stopping conditions can ensure that the enterprise generative artificial intelligence system 802 will not get stuck in an endless loop. This feature can also allow the enterprise generative artificial intelligence system 802 the flexibility of having a different number of iterations for different inputs (e.g., as opposed to having a fixed number of hops). In another example, the orchestrator module 904 can perform resource allocation such as virtualization or load balancing based on computing conditions. In some implementations, the orchestrator module 904 and/or agents 906 include models that can convert (or, transform) an image, database table, and/or other non-text input, into text format (e.g., natural language).

In some embodiments, the orchestrator module 904 can function to cooperate with agents 906 (e.g., retrieval agent module 906-1, unstructured data retriever agent module 906-2, structured data retriever agent module 906-3) to iteratively and non-iteratively process inputs to determine output results or answers, determine context and rationales for informing subsequent iterations, and determine whether large language models (e.g., of the orchestrator 904 and/or comprehension module 916) require additional information to determine answers. For example, the orchestrator module 904 may receive a query and instruct agent 906-1 to retrieve associated information. The retrieval agent module 906-1 may then select unstructured data retriever agent module 906-2 and/or structured data retriever agent module 906-3 depending on whether the orchestrator module 904 wants to retrieve structured or unstructured data records. The appropriate agents 906 can the select the corresponding tools and provide the tool output to the orchestrator module 904 and/or comprehension module 916 for determining a final result.

The orchestrator 904 may also select and swap models as needed. For example, the orchestrator 904 may change out models (e.g., data models, large language models, machine learning models) of the enterprise generative artificial intelligence system 802 at or during run-time in addition to before or after run-time. For example, the orchestrator 904, agents 906, and comprehension module 916 may use particular sets of machine learning models for one domain and other models for different domains. The orchestrator 904 may select and use the appropriate models for a given domain and/or input.

In some embodiments, the orchestrator 904 may combine (e.g., stitch) outputs/results from various agents to create a unified output. For example, one or more of the agent modules 906 may obtain/output a document (or segment(s) thereof) or related information (e.g., text summary or translation), another agent module 906 may obtain/output a database table, and the like. The orchestrator 904 may then use one or more machine learning models (e.g., a large language model and/or another machine learning model) to combine the outputs/results into a unified output (e.g., having a common data format, such as natural language).

In some implementations, the orchestrator 904 pre-processes inputs (e.g., initial inputs) prior to the input being sent to one or more agents 906 for processing. For example, the orchestrator 904 may transform a first portion of an input into an SQL query and send that to an unstructured data retriever agent module 906-2 agent, transform a second portion of the input into an API call and send that to an API agent module 906-7, and the like. In another example, such transformation functionality may be performed by the agents 906 instead of, or in addition to, the orchestrator 904.

The orchestrator module 904 can function to process, extract and/or transform different types of data (e.g., text, database tables, images, video, code, and/or the like). For example, the orchestrator module 904 may take in a database table as input and transform it into natural language describing the database table which can then be provided to the comprehension module 916, which can then process that transformed input to “answer,” or otherwise satisfy a query. In some embodiments, a large language model may be used to process text, while another model may be used to convert (or, transform) an image, database table, and/or other non-text input, into text format (e.g., natural language).

It will be appreciated that, in some embodiments, the orchestrator module 904 can include some or all of the functionality of the comprehension module 916. For example, the comprehension module 916 may be a component of the orchestrator module 904. Similarly, in some embodiments, the comprehension module 916 may include some or all of the functionality of the orchestrator module 904.

In the example of FIG. 9, the agent modules 906 include a variety of different example agent modules 906-1 to 906-N. It will be appreciated that these are shown by way of example, and various embodiments may include different agents instead of, or in addition to, the agents 906-1 to 906-N. In some embodiments, each of the agents 906 comprises hardware and/or software, and include one or more large language models, one or more other machine learning models, and/or functions, to provide reasoning functionality to accomplish a prescribed set of tasks. It will be appreciated that reference to an agent module may refer to the agent itself and/or the component that generates and/or executes the agent. In some embodiments, the orchestrator is a type of agent and may be referred to as an orchestrator agent. Accordingly, reference to orchestrator may refer to the orchestrator itself and/or the component that generates and/or executes the orchestrator.

In various embodiments, some or all the agents 906 can process data having disparate data types and/or data formats. For example, the agent modules 906 may receive a database table or an image as input (e.g., received from a tool 908) and translate the table or image into natural language describing the table or image which can then be output for processing by other modules, models, and/or systems (e.g., the orchestrator module 904 and/or comprehension module 916). In one example, a large language model may be used to process text, while another model may be used to convert (or, transform) an image, database table, and/or other non-text input, into text format (e.g., natural language).

The retrieval agent module 906-1 can function to retrieve structured and unstructured data records. In some embodiments, the retrieval agent module 906-1 can coordinate/instruct the unstructured data retriever agent module 906-2 to retrieve unstructured data records and coordinate/instruct the structured data retriever agent module 906-3 and the type system retriever agent 906-4 to retrieve structured data records. For example, the retrieval agent module 906-1 may cooperate with other agents 906 and tools 908 to generate SQL queries to query an SQL database.

The unstructured data retriever agent module 906-2 can function to retrieve unstructured data records (e.g., from an unstructured datastore) and/or passages (or, segments) of those data records. Unstructured data records may include, for example, text data that is stored on a file system in a format such as PDF, DOCX, MD, HTML, TXT, PPTX, and the like.

In some embodiments, the agent 906-2 can use embeddings (e.g., vectors stored in vector store 940) when retrieving information. For example, the agent 906-2 can use a similarity evaluation or search on the vector datastore 940 to find relevant data records based on k-nearest neighbor, where embeddings that are closer to each other are more likely relevant.

In some embodiments, the unstructured data retriever agent module 906-2 implements a Read-Extract-Answer (REA) data retrieval process and/or a Read-Answer (RA) data retrieval process. More specifically, REA and RA can be appropriate when the system 802 needs to process large amounts of data. For example, a query may identify many different data records and/or passages (e.g., hundreds or thousands of data records and passages). For simplicity, reference to data records may include data records and/or passages.

More specifically, the unstructured data retriever agent module 906-2 can determine whether each data record is relevant to answer the query and filter out the data records that are not relevant. For example, the agent 906-2 can calculate and assign relevance scores (e.g., using a machine learning relevance model) for each of the retrieved data records. The relevance score can be relative to the other retrieved data records. For example, the least relevant data record may be assigned a minimum value (e.g., 0) and the most relevant data record may be assigned a maximum value (e.g., 100). The unstructured data retriever agent module 906-2 may filter out documents that are relevant (or the documents that are not relevant). For example, the unstructured data retriever agent module 906-2 may filter out data records that have a relevance score below a configurable threshold value (e.g., 90). In some embodiments, the number of data records that the unstructured data retriever agent module 906-2 can retrieve for a particular input or query can be user or system defined, and also may be configurable. For example, a system may define that a maximum of 50 data records can be returned.

In some embodiments, a large language model (e.g., of the unstructured data retriever agent module 906-2) can identify key points of the relevant documents and passages, and then provide the key points to a large language model (e.g., a large language model of the orchestrator 904). The large language model can provide a summary which can be used to generate the query answer (e.g., the summary can be the query answer). This can, for example, allow the system 802 to look at a wide diversity of concepts and documents (e.g., as opposed to an iterative process). In some embodiments, if the number of documents or passages is below a threshold value, the unstructured data retriever agent module 906-2 can skip the “extract” step (e.g., summarizing key points), and provide the passages directly to the large language model. This can be referred to as the RA process.

The structured data retriever agent module 906-3 can function to retrieve structured data records, and/or passages (or, segments) thereof, from various structured datastores. For example, structured data records can include tabular data persisted in a relational database, key value store, or external database and modeled or accessed with entity types (or, simply, types). Structured data records can include data records that are structured according to one or more data models (e.g., complex data models) and/or data records that can be retrieved based on the one or more data models. Structured data records can include data records stored in a structured datastore (e.g., a datastore structured according to one or more data models).

In a specific implementations, data models may include a graph structure of objects or types, and the agents 906 and/or tools 908 can traverse the graph in different paths to identify relevant types of the data model (e.g., depending on the query and a plan to answer the query provided by the orchestrator module 904) and can combine multiple tables with complex joins (e.g., as opposed to simply passing a single data from and performing operations on that single table). The paths may be stored in a datastore (e.g., a vector datastore 940) for efficient retrieval.

In some embodiments, the structured data retriever agent module 906-3 can use a variety of different tools to retrieve structured data (e.g., structured data retrieval tool 908-2, filter tool 908-9, projections tool 908-10, group tool 908-11, order tool 908-12, limit tool 908-13, and the like). In some embodiments, once the structured data retriever agent module 906-3 has traversed the data model and retrieved the relevant type(s) and/or subsets of the data model, the structured data retriever agent module 906-3 can then use that information, along with the agent and/or tool outputs, to construct a structured query specification which it can execute against one or more structured datastores to retrieve the structured data records.

The type system retriever agent module 906-4 can function to retrieve types, data models, and/or subsets of data models. For example, a data model may include a variety of different types, and each of the types may describe data fields, operations, and functions. Each type can represent a different object (e.g., a real-word object, such as a machine or sensor in a factor), and each type can include a large language model context that provides context for a large language model. Types can be defined in a natural language format for efficient processing by large language models.

In some embodiments, a type system is designed to be used by different computing systems, application developers, data scientists, operations personnel, and/or other users, to build applications, develop and execute machine learning algorithms, and manage and monitor the state of jobs running on a type system (e.g., an enterprise generative artificial intelligence system in some embodiments). The type system is a framework that enables systems, application developers, data scientists, and other users to effectively communicate with each other using the same language. Accordingly, an application developer can interact with the enterprise generative artificial intelligence system 802 in the same way as a data scientist. For example, they can use the same types, the same methods, and the same features.

In some embodiments, a type system can abstract the complex infrastructure inside the enterprise generative artificial intelligence system 802. In one example, developers may never need to write SQL, CQL, or some other query processing language to access data. When a user reads data, the enterprise generative artificial intelligence system 802 can generate the correct query for the underlying data store, submit the query to the database, and present the results back to the user in the form of a collection of objects or result.

In some embodiments, a type can be similar to a programming language class (e.g., a JAVA class) and describes data fields, operations, and functions (e.g., static functions) that can be called on the type or by one or more applications, but the type is not tied to any particular programming language. A type can be a definition of one or more complex objects that the system 802 can understand. For example, a type can represent a wide range of objects, such as a water pump. Types can be used to model systems (e.g., computing clusters, key-value datastores, file systems, file storage, enterprise datastores, and the like) in addition to objects. In some embodiments, complex relationships, such as “when were which light bulbs in which light fixtures” can be modeled as a type.

The machine learning insight agent module 906-5 can function to obtain and/or process outputs from artificial intelligence applications (e.g., artificial intelligence application insights). For example, the machine learning insight module 906-5 can instruct the text processing tool 908-3 to perform a text processing task (e.g., transform an artificial intelligence application into natural language), an image processing tool 908-4 to perform an image processing task (e.g., generate a natural language summary of an image outputted from artificial intelligence application), a timeseries tool 908-3 to summarize timeseries data (e.g., timeseries data output from an artificial intelligence application), and an API tool 908-6 to perform an API call task (e.g., execute an API call to trigger or access an artificial intelligence application).

The timeseries processing agent 906-6 can function to obtain and/or process timeseries data, such as timeseries data output from various applications (e.g., artificial intelligence applications), machines, sensors, and the like. The timeseries processing agent 906-6 can instruct and/or cooperate with the timeseries processing tool module 908-3 to obtain timeseries data from one or more artificial intelligence applications and/or other data sources.

The API agent module 906-7 can function coordinate and manage communication with other applications. For example, the API agent module 906-7 may instruct the API tool module 908-6 to execute various API calls and then process those tool outputs (e.g., transform into a natural language summary).

The math agent module 906-8 can function to determine whether an agent 906 or large language model needs additional information to generate an answer or result. In some embodiments, the math agent 906-8 may instruct the optimizer tool module 908-8 to execute a variety of different prescriptive analytics functions and mathematical optimizations to assist in the calculation of answers for various problems. For example, the orchestrator module 904 may use the math agent module 906-8 to generate plans, determine whether the orchestrator module 904 needs more information to generate a final result, and the like.

The visualization agent module 906-9 can function to generate one or more visualizations and/or graphical user interfaces, such as dashboards, charts, and the like. For example, the visualization agent module 906-9 may execute visualization tool module 908-7 to generate dashboards based on information retrieved by the other agents and/or information output by the other agents (e.g., natural language summaries of associated tool outputs). The visualization agent module 906-9 may also function to generate summaries (e.g., natural language summaries) of visual elements, such as charts, tables, images, and the like.

The code generation agent module 906-10 can function to instruct the code generation tool module 908-14 to generate source code, machine code, and/or other computer code. For example, the code generation agent module 906-10 may be configured to determine what code is needed (e.g., to satisfy a query, create an application, and the like) and instruct the tool 908-14 to generate that code in a particular language or format.

In some embodiments, the tools 908 are specific functions that agents (e.g., agents 906, orchestrator module 904) can access or execute while attempting to accomplish prescribed task(s) (e.g., of a set of prescribed tasks of a plan determined by the orchestrator module 904). Tools 908 can include software and/or hardware. Tools 908 may also include one or more machine learning models, but they may also include functions without any machine learning model. In some embodiments, tools 908 do not include large language models, although in other embodiments tools may include large language models. In some embodiments, some or all of the agents 906 and/or tools 908 can be manually configured (e.g., by a user). Agents 906 and tools 908 may also normalize data (e.g., to a common data format) before outputting the data.

The unstructured data retrieval tool 908-1 can function to retrieve unstructured data records from an unstructured data store. In some embodiments, the agent 906-2 can use embeddings (e.g., vectors stored in vector store 940) when retrieving information. For example, the agent 906-2 can use a similarity evaluation or search to find relevant data records based on k-nearest neighbor, where embeddings that are closer to each other are more likely relevant. The structured data retrieval tool 908-2 can function to access and retrieve structured data records from a structured datastore (e.g., structured or modeled according to a data model). The structured data retrieval tool 908-2 may be executed by the structured data retriever agent module 906-3).

The text processing tool module 908-3 can function to retrieve and/or transform text (e.g., from unstructured data records) and perform other text processing tasks (e.g., transform a text-based output of artificial intelligence application into natural language). The image processing tool module 908-4 can function to perform an image processing task (e.g., generate a natural language summary of an image). The timeseries processing tool module 908-5 can function to obtain and/or process timeseries data (e.g., output from artificial intelligence applications, sensors, and the like). For example, the timeseries processing tool module 908-3 may be executed one or more of the agents 906 to obtain and process timeseries data. The API tool module 908-6 can function to perform an API call task (e.g., execute an API call to trigger or access an artificial intelligence application). For example, different agents 906 may use the API tool module 906-8 whenever the agent needs to access or trigger another application.

The visualization tool module 908-7 can function to generate one or more visualizations and/or graphical user interfaces, such as dashboards. For example, the visualization tool module 908-7 may generate dashboards based on information retrieved by the other agents and/or information output by the other agents (e.g., natural language summaries of associated tool outputs). The filter tool module 908-9 can function to filter data records, types, and/or the like. For example, the filter tool module 908-9 may filter projections (e.g., fields) identified by the projections tool module 908-10 as part of a structured data retrieval process. In various embodiments, tools 908 can execute in parallel or otherwise.

In some embodiments, the filter tool module 908-9 can identify implicit filters based on a query or other input, and those identified implicit filters can be used as part of a structed data retrieval process. For example, a query may include “When was a premium towel out last?” The filter tool module 908-9 may identify “premium towel” as a filter (e.g., based on an associated type description). The filter tool module 908-9 may also identify contextual datetime filters. For example, a query may include “How many systems when offline yesterday?” The filter tool module 908-9 may determine yesterday's date while accounting for time zone and other relevant data to generate an accurate filter. In some embodiments, the filter tool module 908-9 can validate identified filters prior to the filters being used (e.g., as part a structured data retrieval process).

The projections tool module 908-10 can function to identify and select fields (e.g., type fields, object fields) that are relevant to determine an answer to a query or other input. The group tool module 908-11 can function to group data (e.g., types, tool outputs, and the like) which can then be used to generate structured query requests (e.g., by the structured data retriever agent module 906-3 and/or structured data retrieval tool module 908-2).

The order tool module 908-12 can function to order data (e.g., types, tool outputs, and the like) which can then be used to generate structured query requests (e.g., by the structured data retriever agent module 906-3 and/or unstructured data retrieval tool module 906-2). The limit tool module 908-13 can function to limit the output of a structured data retrieval process. For example, it may limit the number of retrieved data records, types, groups, filters, and or the like.

The code generation tool module 908-14 can function to generate source code, machine code, and/or other computer code. For example, the code generation tool module 908-14 may be configured to generate and/or execute SQL queries, JAVA code, and/the like. The code generation tool module 908-14 may be used to facilities query generation for agents, other tools, large language models, and the like. The code generation tool module 908-15, in some embodiments, may be configured to generate source code for an application or create an application.

The embeddings generator module 912 may function to generate embeddings based on both structured and unstructured data records and/or segments. The embeddings generator module 912 may be the same as the embeddings generator module 128. The embeddings generator module 912 may include one or more models (e.g., embedding models, deep learning models) that can convert and/or transform data records into a vector representation, where the vectors for semantically similar data records (e.g., the content of the data records) are close together in the vector space. This can facilitate retrieval operations by the agents 906 and tools 908.

In some embodiments, the embeddings generator module 912 can generate embeddings using one or more embeddings models (e.g., an implementation of the ColBERT embedding model). The embeddings may include a numerical representation for unstructured and/or structured data records that captures the semantic or contextual meaning of the data records. For example, the embeddings may be represented by one or more vectors. The embeddings may be used when retrieving data records and performing similarity evaluations or other aspects of retrieval operations. The embeddings may be stored in an embeddings index (e.g., vector datastore 940). In some embodiments, the vector store 940 is a type of database that is specifically optimized for storing embeddings and retrieving embeddings using a similarity heuristic (e.g., an approximate nearest neighbor (ANN) algorithm) that can be implemented by the agents 906 and/or tools 908. In one example, the vector store 940 may comprise an implementation of a FAISS vector store.

The chunking module 910 may function to process (e.g., chunk) a corpus of data records (e.g., of one or more enterprise systems and/or external systems) for handling by various systems (e.g., enterprise generative artificial intelligence system 802). The chunking module 910 can partition data records and insert or append a respective header for each chunk. The header may include one or more attributes describing the chunk. Segments may include the header along with a passage of a text document, a portion of database table, a model or sub-model, and so forth. For simplicity, reference to a passage may include the segment and/or other content (e.g., text) of a segment. Segments can be stored in a segment datastore. Chunking can be rule-based.

In some implementations, the chunking module 910 can preprocess the data records and/or segments to generate corresponding contextual information. In some embodiments, the contextual information may be included and/or represented in contextual metadata, and/or the contextual metadata may be generated from the contextual information. The contextual information may improve security, as well as accuracy and reliability of associated retrieval operations. In one example, contextual information includes contextual metadata. The contextual information can include references between segments and/or data records. For example, the references may indicate relationships that can be used (e.g., traversed) when performing similarity evaluations or other aspects of retrieval operations (e.g., by one or more of the agents 906). Contextual information may also include information that can assist a large language model in generating a plan and/or answers. For example, the chunking module 910 may generate contextual information for structured data chunks (or passages) that include natural language descriptions of the data records, locations of related data records, and the like.

The contextual information may include access controls. In some implementations, contextual information provides user-based access controls (e.g., role-based access control) to associated data records and/or segments. More specifically, the contextual information can indicate user roles that may access a corresponding segment and/or data record, and/or user roles that may not access a corresponding segment and/or data record. The contextual information may be stored in headers of the data records and/or data record segments. The contextual information may maintain references between data records and/or data record segments. The chunking module 910 may generate contextual information before, after, or at the same time as the associated embeddings are generated. For example, embeddings may be created using context information, or embeddings may be enriched with contextual information. The contextual information may be used by the chunking module 910 to map relationships between data records and/or segments of one or more enterprises or enterprise systems and store those relationships in a data model. In one example, the chunking module 910 implements a word2vec algorithm. In some implementations, the chunking module 910 utilizes models trained on domain-specific (or, industry-specific) datasets.

In some embodiments, the chunking module 910 may perform some or all of the functionality described herein periodically (e.g., in batches), on-demand, and/or in real time. For example, the chunking module 910 may periodically trigger, on-demand trigger, manually trigger, and/or automatically trigger, the chunking described herein. In some implementations, subsequent chunking operations may only incorporate changes relative to previous chunking operations (e.g., the “delta”).

In some implementations, the embeddings generator module 912 generates enriched embeddings. For example, the chunking module 910 may generate enriched embeddings based on the contextual information, data records, and/or data record segments. An enriched embedding may comprise a vector value based on an embedding vector and the contextual information. In some embodiments, an enriched embedding comprises the embedding vector value along with the contextual metadata including the contextual information. Enriched embeddings may be indexed in an enriched embeddings datastore (e.g., a vector datastore 940). The agents 906 and/or tools 908 may retrieve unstructured and/or structured data records based on enriched embeddings. In some embodiments, the contextual information may be included and/or represented in contextual metadata, and/or the contextual metadata may be generated from the contextual information.

The crawling module 914 may function to scan and/or crawl disparate data sources (e.g., enterprise data sources, external data sources) across different domains. The crawling module 914 can identify existing data records, new data records, and/or data records that have been updated. The crawling module 914 may notify the chunking module 910 of new data records and data records that have been updated, and the chunking module 910 can chunk those data records. In some embodiments, the crawling module 914 can function and/or trigger operation periodically, on-demand, and/or in real-time.

In some embodiments, the crawling module 914 may function to scan and/or crawl disparate data sources (e.g., enterprise systems 504, external systems 506) across different domains (e.g., data domains). This can identify existing data records, new data records, and/or data records that have been updated. The crawling module 914 may notify the chunking module 910 of new data records and data records that have been updated, and the chunking module 910 can chunk those data records. In some embodiments, the crawling module 914 can function and/or trigger operation periodically, on-demand, and/or in real-time.

In some implementations, the information sources can include model registries that store various models (e.g., machine learning models, large language models, multimodal models). The models may be trained on generic datasets and/or domain-specific datasets. The processes described herein can be applied to various model registries. For example, models may be associated with an embedding value (e.g., generated by an embedding model) to facilitate model retrievals.

In some embodiments, the chunking module 910, embeddings generator module 912, and/or crawling module 914 can implement the functionality described in FIG. 2 (e.g., extracting information, identifying images and tables, chunking text, extracting information, generating an information graph, and the like).

The enterprise generative artificial intelligence system 802 may perform some or all of the functionality described herein periodically (e.g., in batches), on-demand, and/or in real time. For example, the system may periodically trigger, on-demand trigger, manually trigger, or automatically trigger, the intelligent crawling and indexing described herein. In some implementations, subsequent crawling and indexing operations may only incorporate changes relative to a previous crawling and indexing operations (e.g., the “delta”).

The comprehension module 916 can function to process inputs to determine results (e.g., “answers”), determine rationales for results, and determine whether the comprehension module 916 needs more information to determine results. The comprehension module 916 may output information (e.g., results or additional queries) in a natural language format or machine language format. In some implementations, features of one or more models of the comprehension module define conditions or functions that determine if more information is needed to satisfy the initial input or if there is enough information to satisfy the initial input.

In some embodiments, the comprehension module 916 includes one or more large language models. The large language models may be configured to generate and process context, as well as the other information described herein. The comprehension module 916 may also include other language models that pre-process inputs (e.g., a user query) prior to inputs being provided to the agents for handling. The comprehension module 916 may also include one or more large language models that process outputs from other models and modules (e.g., models of the agents 906). The comprehension module 916 may also include another large language model for processing answers from one large language model into a format more consistent with a final answer that can be transmitted to various users and/or systems (e.g., users or systems that provided the initial query or other intended recipient of the answer).

For example, the comprehension module 916 may format answers according to various viewpoints. Viewpoints can be based on a type of user (e.g., human or machine), user roles (e.g., e.g., data scientist, engineer, director, and the like), access permissions, and the like. Accordingly, viewpoints enable the comprehension module 916 to generate and provide an answer specifically targeted for the recipient. The comprehension module 916 may also notify users and systems if it cannot find an answer (e.g., as opposed to presenting an answer that is likely faulty or biased).

In some implementations, features of one or more large language models of the comprehension module 916 define conditions or functions that determine if more information is needed to satisfy the initial input or if there is enough information to satisfy the initial input. The large language models of the comprehension module 916 may also define stopping conditions that indicate a stopping threshold condition indicating a maximum number of iterations that may be performed before the iterative process is terminated.

In some embodiments, the comprehension module 916 can generate and store rationales and contexts (e.g., in one or more datastores). The rationale may be the reasoning used by the comprehension module 916 to determine an output (e.g., natural language output, an indication that it needs more information, an indication that it can satisfy the initial input). The comprehension module 916 may generate context based on the rationale. In some implementations, the context comprises a concatenation and/or annotation of one or more segments of data records, and/or embeddings associated therewith, along with a mapping of the concatenations and/or annotations. For example, the mapping may indicate relationships between different segments, a weighted or relative value associated with the different segments, and/or the like. The rational and/or context may be included in the prompts that are provided to the large language models.

In some embodiments, the comprehension module 916 includes a query and rational generator that generates queries or other inputs for models (e.g., large language models, other machine learning models) and/or generates and stores the rationales and contexts (e.g., in the datastore 960). The query and rational generator can function to process, extract and/or transform different types of data (e.g., text, database tables, images, video, code, and/or the like). For example, the query and rational generator may take in a database table as input and transform it into natural language describing the database table which can then be provided to the one or more other models (e.g., large language models) of the comprehension module 916, which can then process that transformed input to “answer,” or otherwise satisfy a query. In some implementations, the query and rational generator includes models that can convert (or, transform) an image, database table, and/or other non-text input, into text format (e.g., natural language). It will be appreciated that although queries are used in various examples throughout this paper, other types of inputs (e.g., instruction sets) may be processed in the same or similar manner as described with respect to queries.

In some embodiments, the comprehension module 916 can use different models for different domains. For example, different domains may correspond to different industries (e.g., aerospace, defense), different technological environments (e.g., on premise, air-gapped, cloud-native), different enterprises or organizations, and/or the like. Accordingly, the comprehension module 916 can use particular models (e.g., data models and/or large language models) for a particular domain (e.g., a data model describing properties and relationships of aerospace objects and a large language model trained on aerospace-specific datasets) and use another data model and/or large language model for another domain (e.g., data model describing properties and relationships of defense-specific objects and a large language model trained on defense-specific datasets), and so forth.

In some embodiments, the orchestrator module 904 includes some or all of the functionality and/or structure of the comprehension module 916 and/or 906, described further below. Similarly, in some embodiments, the comprehension module 916 may include some or all of the functionality and/or structure of the orchestrator module 904.

In some embodiments, the comprehension module 916 can function to generate large language model prompts (or, simply, prompts) and prompt templates. For example, the comprehension module 916 may generate a prompt template for processing an initial input, a prompt template for processing iterative inputs (i.e., inputs received during the iteration process after the initial input is processed), and another prompt template for the output result phase (i.e., when the comprehension module 916 has determined that it has enough information and/or a stopping condition is satisfied). The comprehension module 916 may modify the appropriate prompt template depending on a phase of the iterative process. For example, prompt templates can be modified to generate prompts that include rationales and contexts, which can inform subsequent iterations.

The enterprise access control module 918 can function to provide enterprise access controls (e.g., layers and/or protocols) for the enterprise generative artificial intelligence system 802, associated systems (e.g., enterprise systems), and/or environments (e.g., enterprise information environments). The enterprise access control module 918 can provide functionality for enforcement of access control policies with respect to generating results (e.g., preventing the orchestrator module 904 and/or comprehension module 916 from generating results that include sensitive information) and/or filtering results that have already been generated prior to providing a final result.

In some implementations, the enterprise access control module 918 may evaluate (e.g., using access control lists) whether a user is authorized to access all or only a portion of a result (e.g., answer). For example, a user can provide a query associated with a first department or sub-unit of an organization. Members of that department or sub-unit may be restricted from accessing certain pieces of data, types of data, data models, or other aspects of a data domain in which a search is to be performed. Where the initial results include data for which access by the user is restricted, the enterprise access control module 918 can determine how such restricted data is to be handled, such as to omit the restricted data entirely, omit the restricted data but indicate the results include data for which access by the user is restricted, or provide information related to all of the initial results. In the example where restricted data is omitted entirely, a final set of results may be returned for presentation to the user, where the final set of results does not inform the user that a portion of the initial results have been omitted. In the example where the restricted data is omitted but an indication of the presence of the restricted data is provided to the user, the final results may include only those results for which the user is authorized for access, but may include information indicating there were X number of initial results but only Y results are outputted, where Y<X. In the third example described above, all of the results may be outputted to the user, including results for which access is restricted by the user.

Additionally, or alternatively, the enterprise access control module 918 may communicate with one or more other modules to obtain information that may be used to enforce access permissions/restrictions in connection with performing retrieval operations instead of for controlling presentation of the results to the user. For example, enterprise access control module 918 may restrict the data sources to which retrieval operations are applied, such as to not apply a retrieval operation to portions of the data sources for which user access is denied and apply the retrieval operations to portions of the data sources for which user access is permitted. It is noted that the exemplary techniques described above for enforcing access restrictions have been provided for purposes of illustration, rather than by way of limitation and it should be understood that modules operating in accordance with embodiments of the present disclosure may implement other techniques to present results via an interface based on access restrictions.

In some embodiments, to facilitate the enforcement of access restrictions in connection with searches performed by the enterprise generative artificial intelligence system 802, the enterprise access control module 918 may store information associated with access restrictions or permissions for each user. To retrieve the relevant restriction data for a user, the enterprise access control module 918 may receive information identifying the user in connection with the input or upon the user logging into system on which the enterprise access control module 918 is executing. The enterprise access control module 918 may use the information identifying the user to retrieve appropriate restriction data for supporting enforcement of access restrictions in connection with an enterprise search. In some embodiments, the enterprise access control module 918 can include credential management functionality of a model driven architecture in which the enterprise generative artificial intelligence system 802 is deployed or may be a remote credential management system communicatively coupled to the enterprise generative artificial intelligence system 802 via a network.

The artificial intelligence traceability module 920 can function to provide traceability and/or explainability of answers generated by the enterprise generative artificial intelligence system 802. For example, the artificial intelligence traceability module 920 can indicate portions of data records used to generate the answers and their respect data sources. The artificial intelligence traceability module 920 can also function to corroborate large language model outputs. For example, the artificial intelligence traceability module 920 can provide sources citations automatically and/or on-demand to corroborate or validate large language model outputs. The artificial intelligence traceability module 920 may also determine a compatibility of the different sources (e.g., data records, passages) that were used to generate a large language model output. For example, the artificial intelligence traceability module 920 may identify data records that contradict each other (e.g., one of the data records indicate that John Doe is an employee at Acme corporation and another data record indicates that John Doc works at a different company) and provide a notification that the output was generated based on contradictory on conflicting information. The artificial intelligence traceability module 920 may cooperate with, and/or include the functionality of the anti-hallucination and attribution module 934.

The parallelization module 922 can function to control the parallelization of the various systems, modules, agents, models, and processes described herein. For example, the parallelization module 922 may spawn parallel executions of different agents and/or orchestrators. The parallelization module 922 may be controlled by the orchestrator module 904.

The model generation module 924 can function to obtain, generate, and/or modify some or all of the different types of models described herein (e.g., machine learning models, large language models, data models). In some implementations, the model generation module 924 can use a variety of machine learning techniques or algorithms to generate models. As used herein, artificial intelligence and/or machine learning can include Bayesian algorithms and/or models, deep learning algorithms and/or models (e.g., artificial neural networks, convolutional neural networks), gap analysis algorithms and/or models, supervised learning techniques and/or models, unsupervised learning algorithms and/or models, semi-supervised learning techniques and/or models random forest algorithms and/or models, similarity learning and/or distance algorithms, generative artificial intelligence algorithms and models, clustering algorithms and/or models, transformer-based algorithms and/or models, neural network transformer-based machine learning algorithms and/or models, reinforcement learning algorithms and/or models, and/or the like. The algorithms may be used to generate the corresponding models. For example, the algorithms may be executed on datasets (e.g., domain-specific data sets, enterprise datasets) to generate and/or output the corresponding models.

In some embodiments, a large language model is a deep learning model (e.g., generated by a deep learning algorithm) that can recognize, summarize, translate, predict, and/or generate text and other content based on knowledge gained from massive datasets. Large language models may comprise transformer-based models. Large language models can include Google's BERT, OpenAI's GPT-3, and Microsoft's Transformer. Large language models can process vast amounts of data, leading to improved accuracy in prediction and classification tasks. The large language models can use this information to learn patterns and relationships, which can help them make improved predictions and groupings relative to other machine learning models. Large language models can include artificial neural network transformers that are pre-trained using supervised and/or semi-supervised learning techniques. In some embodiments, large language models comprise deep learning models specialized in text generation. Large language models, in some embodiments, may be characterized by a significant number of parameters (e.g., in the tens or hundreds of billions of parameters) and the large corpuses of text used to train them.

Although the systems and processes described herein use large language models, it will be appreciated that other embodiments may use different types of machine learning models instead of, or in addition to, large language models. For example, an orchestrator 904 may use deep learning models specifically designed to receive non-natural language inputs (e.g., images, video, audio) and provide natural language outputs (e.g., summaries) and/or other types of output (e.g., a video summary).

The model deployment module 926 can function to deploy some or all of the different types of models described herein. In some implementations, the model deployment module 926 can deploy models before or after a deployment of enterprise generative artificial intelligence system. For example, the model deployment module 926 may cooperate with the model optimization module 928 to swap or other change large language models of an enterprise generative artificial intelligence system.

In some implementations, a model registry 950 can store various models (e.g., machine learning models, large language models, data models) and/or model configurations. The models may be trained on generic datasets and/or domain-specific datasets. For example, the model registry may store different configurations of various large language models (e.g., which can be deployed or swapped in an enterprise generative artificial intelligence system 802). In some embodiments, each of the models may be associated with an embedding value, or enriched embedding value, to facilitate retrieval operations (e.g., in the same or similar manner as data records retrievals).

The model optimization module 928 can function to enable tuning and learning by the modules (e.g., the comprehension module 916) and/or the models (e.g., machine learning models, large language models) described herein. For example, the model optimization module 928 may tune the comprehension module 916 and/or orchestrator module 904 (and/or models thereof) based on tracking user interactions within systems, capturing explicit feedback (e.g., through a training user interface), implicit feedback, and/or the like. In some example implementations, the model optimization module 928 can use reinforcement learning to accelerate knowledge base bootstrapping. Reinforcement learning can be used for explicit bootstrapping of various systems (e.g., the enterprise generative artificial intelligence system 802) with instrumentation of time spent, results clicked on, and/or the like. Example aspects of the model optimization module 928 include an innovative learning framework that can bootstrap models for different enterprise environments. Example aspects of the model optimization module 928 can include an innovative learning framework that can bootstrap models for different enterprise environments.

In some embodiments, reinforcement learning is a machine learning training method based on rewarding desired behaviors and/or punishing undesired ones. In general, a reinforcement learning agent is able to perceive and interpret its environment, take actions and learn through trial and error. Reinforcement Learning uses algorithms and models to determine optimal behavior in an environment to obtain maximum reward. This optimal behavior is learned through interactions with the environment and observations of how it responds. In the absence of a supervisor, the learner must independently discover the sequence of actions that maximize the reward. This discovery process is akin to a trial-and-error search. The quality of actions is measured by not just the immediate reward they return, but also the delayed reward they might fetch. As it can learn the actions that result in eventual success in an unseen environment without the help of a supervisor, reinforcement learning is a very powerful algorithm. ColBERT is an example retriever model, enabling scalable BERT-based search over large text collections (e.g., in tens of milliseconds). ColBERT uses a late interaction architecture that independently encodes a query and a document using BERT and then employs a “cheap” yet powerful interaction step that models their fine-grained similarity. Beyond reducing the cost of re-ranking documents retrieved by a traditional model, ColBERT's pruning-friendly interaction mechanism enables leveraging vector-similarity indexes for end-to-end retrieval directly from a large document collection.

In some embodiments, the model optimization module 928 can retrain models (e.g., transformer-based natural language machine learning models) periodically, on-demand, and/or in real-time. In some example implementations, corresponding candidate model (e.g., candidate transformer-based natural language machine learning models) can be trained based on the user selections and the model optimization module 928 can replace some or all of the models with one or more candidate models that have been trained on the received user selections.

In some embodiments, the model optimization module 928 can change out models of the enterprise generative artificial intelligence system at or during run-time in addition to before or after run-time. For example, the orchestrator module 904 comprehension module 916, and/or agents 906 may use particular sets of machine learning models for one domain and other models for different domains. The model swapping module may select and use the appropriate models for a given domain. This may even occur during the iteration process. For example, as new queries are generated by the comprehension module 916, the domain may change which may trigger the model swapping module to select and deploy a different model that is appropriate for that domain.

In some embodiments, the model optimization module 928 can train generative artificial intelligence models to develop different types of responses (e.g., best results, ranked results, smart cards, chatbot, new content generation, and/or the like).

In some embodiments, the model optimization module 928 can retrain models (e.g., large language models) periodically, on-demand, and/or in real-time. In some example implementations, corresponding candidate models can be trained based on the user selections and the system can replace some or all of the models with one or more candidate models that have been trained on the received user selections.

The interface module 930 can function to receive inputs (e.g., complex inputs) from users and/or systems. The interface module 930 can also generate and/or transmit outputs. Inputs can include system inputs and user inputs. For example, inputs can include instructions sets, queries, natural language inputs or other human-readable inputs, machine-readable inputs, and/or the like. Similarly, outputs can also include system outputs and human-readable outputs. In some embodiments, an input (e.g., request, query) can be input in various natural forms for easy human interaction (e.g., basic text box interface, image processing, voice activation, and/or the like) and processed to rapidly find relevant and responsive information.

In some embodiments, the interface module 930 can function to generate graphical user interface components (e.g., server-side graphical user interface components) that can be rendered as complete graphical user interfaces on the enterprise generative artificial intelligence system 802 and/or other systems. For example, the interface module 930 can function to present an interactive graphical user interface for displaying and receiving information.

The communication module 932 can function to send requests, transmit and receive communications, and/or otherwise provide communication with one or more of the systems, modules, engines, layers, devices, datastores, and/or other components described herein. In a specific implementation, the communication module 932 may function to encrypt and decrypt communications. The communication module 932 may function to send requests to and receive data from one or more systems through a network or a portion of a network (e.g., communication network 808). In a specific implementation, the communication module 932 may send requests and receive data through a connection, all or a portion of which can be a wireless connection. The communication module 932 may request and receive messages, and/or other communications from associated systems, modules, layers, and/or the like. Communications may be stored in the enterprise generative artificial intelligence system datastore 970.

In some embodiments, the configuration, coordination, and cooperation of the orchestrator module 904, agents 906, tools 908, and/or other modules of the enterprise generative artificial intelligence system 802 (e.g., comprehension module 916) enables the enterprise generative artificial intelligence system 802 to provide a multi-hop architecture that enables complex reasoning over multiple agents 906, tools 908, and data sources (e.g., vector datastores, feature datastores, data models, enterprise datastores, unstructured data sources, structured data sources, and the like). In various embodiments, some or all of the modules of enterprise generative artificial intelligence system 802 can be configured manually (e.g., by a user) and/or automatically (e.g., without requiring user input). For example, large language model prompts can be configured, tool 908 descriptions can be configured (e.g., for more efficient utilization by agents 906 and the orchestrator module 904), and a number of maximum hops or iterations can be configured. In one example, the orchestrator module 904 receives a query from a user, and the orchestrator module 904 determines a plan for answering the query and selects the agents 906 and/or tools 908 to execute a prescribed set of tasks enacting the plan to answer the query. The agents 906 and/or tools 908 execute the prescribed set of tasks, and the orchestrator module 904 observes the result. The orchestrator module 904 determines whether to submit a final answer or whether the orchestrator module 904 needs more information. If the orchestrator module 904 has enough information, it can generate and/or provide the final answer. Otherwise, the orchestrator module 904 can create another prescribed set of tasks, and the process can continue until the orchestrator module 904 has enough information to answer or if a stopping condition is satisfied (e.g., a maximum number of hops).

The anti-hallucination and attribution module 934 may be the same as the anti-hallucination and attribution module 110. The anti-hallucination and attribution module 934 may be an extension of the comprehension module 916 and/or included in the comprehension module 916.

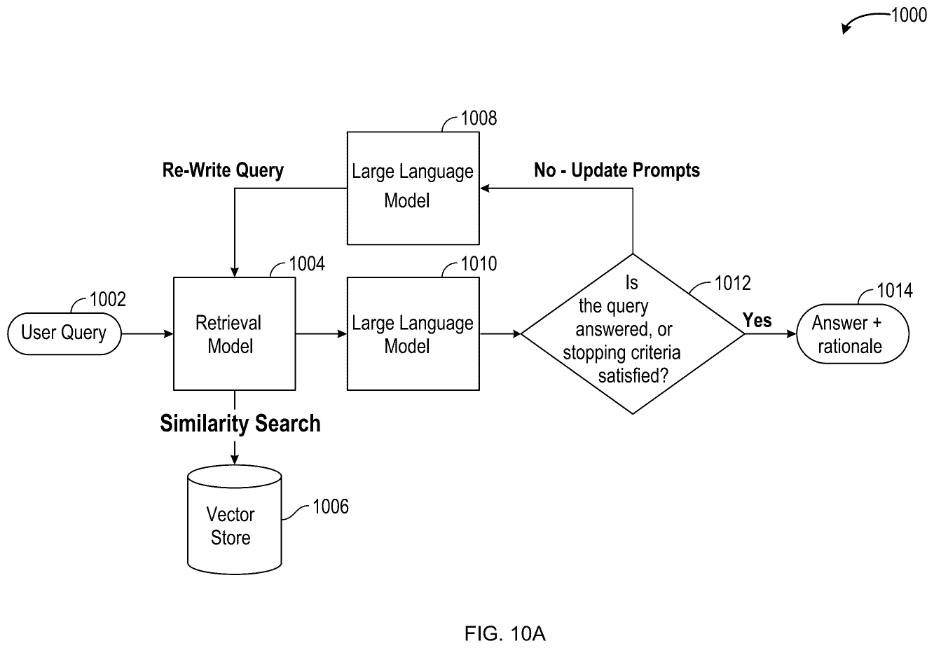

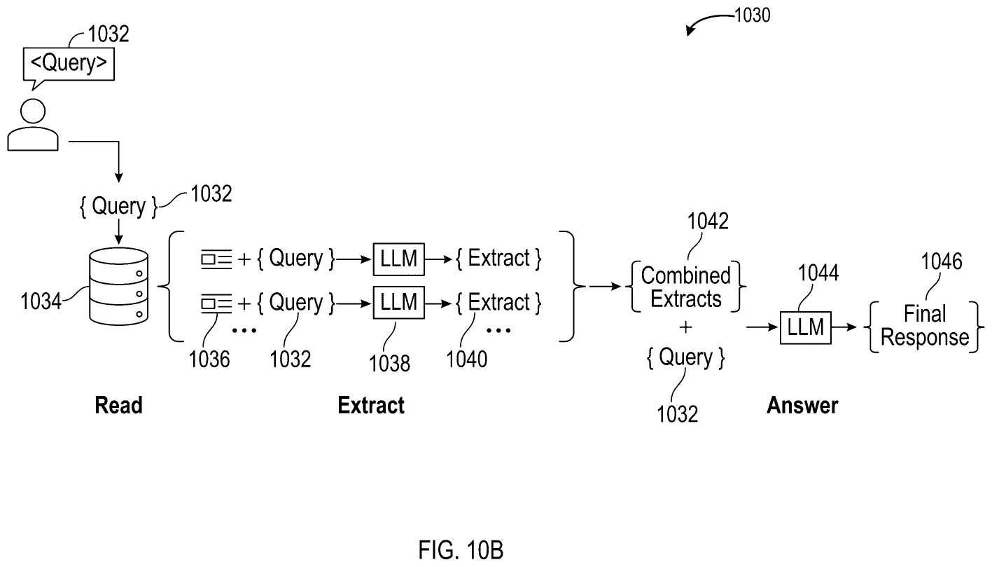

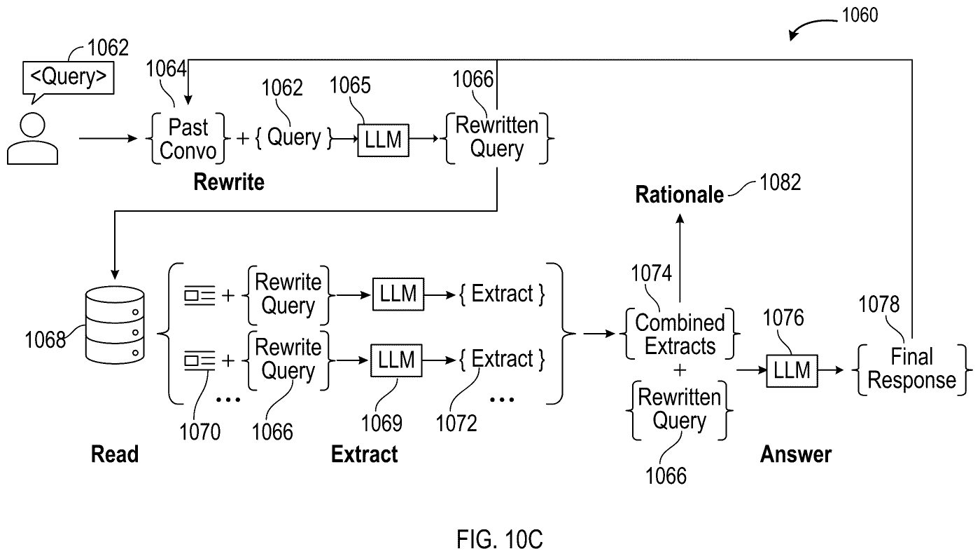

FIG. 10A depicts a flowchart 1000 of an example iterative generative artificial intelligence process using unstructured data according to some embodiments. This example process may be implemented by an enterprise generative artificial intelligence system (e.g., enterprise generative artificial intelligence system 802). In this and other flowcharts and/or sequence diagrams, the flowchart illustrates by way of example a sequence of steps. It should be understood that some or all of the steps may be repeated, reorganized for parallel execution, and/or reordered, as applicable. Moreover, some steps that could have been included may have been removed to avoid providing too much information for the sake of clarity and some steps that were included could be removed but may have been included for the sake of illustrative clarity.

In step 1002, a user query is provided to a retrieval model (e.g., a retriever module of a retrieval agent module). In step 1004, the retrieval model receives the query and performs a similarly search (e.g., an ANN-based search) of the vector store 1006. The retrieved information is returned to the retriever model and provided to a large language model in step 1010. In step 1012, a large language model (e.g., the large language model used in step 1010 and/or a different large language model) determines whether additional information is needed to answer the user query. If more information is needed, steps 1004-1012 can be iteratively repeated with updated large language model prompts and/or queries (e.g., using a large language model in step 1008) until the large language model has enough information to answer the query or a stopping condition is satisfied (e.g., a maximum number of iterations have neem performed). In step 1014, the answer (e.g., the final result if there is enough information for a large language model to determine an answer or “I don't know” if the stopping condition was satisfied before it could receive enough information) is generated and/or presented. The final result may also include the rationale used by the large language model to generate the answer. The large language models used in steps 1008 and 1010 may be the same large language model and/or different large language model.

FIG. 10B depicts a flowchart 1030 of an example non-iterative generative artificial intelligence process using unstructured data according to some embodiments. This example process may be implemented by an enterprise generative artificial intelligence system (e.g., enterprise generative artificial intelligence system 802). In these and other flowcharts and/or sequence diagrams, the flowchart illustrates by way of example a sequence of steps. It should be understood that some or all of the steps may be repeated, reorganized for parallel execution, and/or reordered, as applicable. Moreover, some steps that could have been included may have been removed to avoid providing too much information for the sake of clarity and some steps that were included could be removed but may have been included for the sake of illustrative clarity.

In step 1032, a query is received. The query 1032 is executed against a vector store 1034 and relevant passages 1036 are retrieved. In some embodiments, the user query 1032 is pre-processed (e.g., by an orchestrator) prior to being applied against the vector store 1034 to retrieve passages 1036. For example, the query 1032 may be translated, transformed, and the like. Since complex inputs can be difficult for vector stores to handle, the system can generate a new query, or multiple shorter queries, from the user query 1032 that the vector store 1034 can efficiently and accurately handle. The query 1032 and the passages 1036 provided to a large language model 1038 which can create an extract 1040 (e.g., a summary of the passage) for each passages. The extracts are combined (e.g., concatenated) in step 1042 and provided to a large language model 1044 along with the query 1032. In some embodiments, the extract steps are optional, and the passages may be concatenated and provided to the large language model 1044 instead of the extracts. The large language model 1044 can generate a final response based on the query 1032 and the combined extracts 1042. In some embodiments, the large language model 1044 may post-process (e.g., by the orchestrator) the result prior to being provided to the user. For example, it can be translated, formatted based on viewpoints, include citations and attributions, and so forth.

FIG. 10C depicts a flowchart 1060 of an example non-iterative generative artificial intelligence process using unstructured data according to some embodiments. This example process may be implemented by an enterprise generative artificial intelligence system (e.g., enterprise generative artificial intelligence system 802). In these and other flowcharts and/or sequence diagrams, the flowchart illustrates by way of example a sequence of steps. It should be understood that some or all of the steps may be repeated, reorganized for parallel execution, and/or reordered, as applicable. Moreover, some steps that could have been included may have been removed to avoid providing too much information for the sake of clarity and some steps that were included could be removed but may have been included for the sake of illustrative clarity.

In step 1062, a query is received. For example, the query may be “how much wine do they produce?” This query would be difficult for traditional large language models to process and would typically result in large language model hallucination because it is not clear how to process the “they” in the query 1062. To address this issue, an enterprise generative artificial intelligence system may use context 1064 to generate an improved query. For example, a previous conversation 1064 (e.g., as part of a chat with a chat bot) may have included a conversation about France. The system can provide France as contextual information 1064 to generate a new query 1066, such as “How much wine does France produce?” which can prevent the large language model from hallucinating and allow the large language model to provide an accurate and reliable final result 1078.

More specifically, the enterprise generative artificial intelligence system can generate a rewritten query 1066 (e.g., using large language model 1065) which can be executed against the vector store 1068 to retrieve passages 1070. In some embodiments, the rewritten query 1066 can be pre-processed (e.g., by an orchestrator) prior to being applied against the vector store 1068. For example, the rewritten query 1066 may be translated, transformed, and the like. Since complex inputs are difficult for vector stores to handle, the system can generate a new query, or multiple shorter queries, from the rewritten query 1066 that the vector store 1068 can efficiently and accurately handle. In some embodiments, this pre-processing may be performed when the rewritten query is generated (e.g., rewriting the query includes the pre-processing steps).

The rewritten query 1066 and the passages 1070 are provided to a large language model 1069 which can create an extract 1072 (e.g., a summary of the passage) for each passage. The extracts 1072 are combined (e.g., concatenated) in step 1074 and provided to a large language model 1076 along with the rewritten query 1066. The enterprise generative artificial intelligence system can use the combined extracts 1074 to generate a rationale 1082 for determining the final response 1078. For example, the large language model 1076 may generate the final response 1078 based on the rationale 1082 and/or present the rationale 1082 (or summary of the rationale) along with the final response 1078 (e.g., for citations or attribution purposes).

In some embodiments, the extract steps are optional, and the passages may be concatenated and provided to the large language model 1076 instead of the extracts or combined extracts. The large language model 1044 can generate a final response 1078 based on the rewritten query 1066 and the combined extracts 1074. In some embodiments, the large language model 1076 may post-process (e.g., by the orchestrator) the result prior to the final result 1078 being provided to the user. For example, it can be translated, formatted based on viewpoints, include citations and attributions, and so forth.

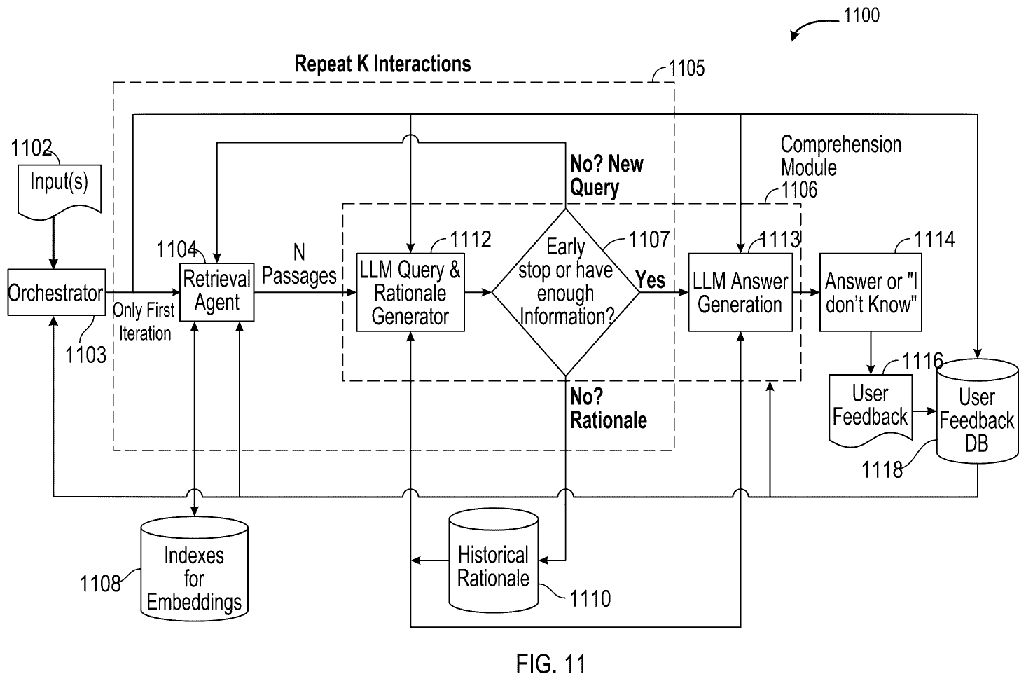

FIG. 11 depicts a flowchart 1100 of an example iterative generative artificial intelligence process using unstructured data according to some embodiments. This example process may be implemented by an enterprise generative artificial intelligence system (e.g., enterprise generative artificial intelligence system 802). In this and other flowcharts and/or sequence diagrams, the flowchart illustrates by way of example a sequence of steps. It should be understood that some or all of the steps may be repeated, reorganized for parallel execution, and/or reordered, as applicable. Moreover, some steps that could have been included may have been removed to avoid providing too much information for the sake of clarity and some steps that were included could be removed but may have been included for the sake of illustrative clarity.

In the example of FIG. 11, an enterprise generative artificial intelligence system (e.g., enterprise generative artificial intelligence system 802) includes one or more retrieval modules 1104 and one or more comprehension modules 1106. For example, the retrieval module 1104 can include one or more large language models, and the comprehension module can include one or more other large language models. These modules, and the iterative interactions (e.g., communication) between these modules, can allow enterprise generative artificial intelligence systems to achieve the technical features and technical benefits discussed herein.

In the example of FIG. 11, the enterprise generative artificial intelligence system can receive an initial input 1102 from a user or another system. For example, an orchestrator module 1103 may receive the input 1102. The enterprise generative artificial intelligence system can provide that input to a retrieval module 1104 (e.g., corresponding to one or more of the agents 906 and/or tools 908) which can then reach out and “retrieve” information from the embeddings store 1108. For example, the retrieval module 1104 may retrieve passages based on the input by using one or more similarity heuristics (e.g., ANN) algorithm) executed on the embeddings store 1108 (e.g., one or more vector stores) to retrieve passages (or, data records) relevant to the input.

The enterprise generative artificial intelligence system can use that retrieved information to generate an initial prompt for the comprehension module 1106. The comprehension module 1106 can process that initial prompt and determine whether it has enough information to satisfy criteria based on the initial input (e.g., answer a question). See, e.g., step 1107. If it has enough information to satisfy the initial input, the comprehension module can then provide the result to a recipient (e.g., see, e.g., step 1113), such as the user or system that provided the initial input. However, if the comprehension module 1106 determines that it does not have enough information to satisfy criteria based on the initial input, it can further synthesize information via the iterative process which provides the core benefit of the system.

There could be many reasons that the comprehension module 1106 may need additional information. For example, traditional systems only use a single pass process which only addresses a portion of a complex input. The enterprise generative artificial intelligence system addresses this problem by triggering subsequent iterations to solve the remaining portions of the complex input, as well as including context to further refine the process.

More specifically, if the comprehension module 1106 determines that it needs additional information to satisfy the initial input, it can generate context-specific data (or, simply, “context”) that will inform future iterations of the process and help the system more efficiently and accurately satisfy the initial input. The context is based on the rationale used by the comprehension module 1106 when it is processing queries (or other inputs). For example, the comprehension module 1106 may receive segments of information retrieved by the retrieval module 1104. The segments may be passages of data record(s), for example, and the segments may be associated with embeddings from an embeddings datastore 1108 that facilitates processing by the comprehension module 1106. A query and rational generator 1112 of the comprehension module 1106 can process the information and generate a rationale for why it produced the result that it did. That rationale can be stored by the enterprise generative artificial intelligence system in an historical rational datastore 1110 and provide the foundation for the context subsequent iterations.

More specifically, subsequent iterations can include the comprehension module 1106 generating a new query, request, or other output that is then passed back to the retrieval module. The retrieval module 1104 can process that new query and retrieves additional information. The system then generates a new prompt based on the additional information and the context. The comprehension module 1106 can process the new prompt and again determines if it needs additional information. If it needs additional information, the enterprise generative artificial intelligence system can repeat (e.g., iterate) this process until the comprehension module 1106 can satisfy criteria based on the initial input, at which point the comprehension module 1106 can generate the output result 1114 (e.g., “answer” or “I don't know”). For example, generating the answer “I don't know” if no relevant passages have been generated or retrieved (e.g., by applying a rule of the comprehension module 1106) and/or not enough relevant passages have been generated, retrieved, and/or extracted, the comprehension module 1106 can prevent hallucination and increase the performance on the “I don't know” queries while saving a call to the models (e.g., large language models).

In some embodiments, whether there is enough information may be determined and/or correlated based on the number of passages that are retrieved but no relevant information was extracted (e.g., by the comprehension module 1106). For example, a threshold number or percentage of the retrieved passage that had relevant information extracted may need to be satisfied (e.g., a particular number or percentage of the retrieved passages) for the enterprise comprehension module 1106 to determine that it has enough information to answer the query. In another example, a threshold number or percentage of the retrieved passages that had no relevant information extracted (e.g., 4 passages or 80% of the retrieved passages) may cause the enterprise comprehension module 1106 to determine that it does not have enough information to answer the query.

The enterprise generative artificial intelligence system may also implement supervisory functions, such as a stopping condition which prevents the system from hallucinating or otherwise providing an erroneous answer. The stopping condition can also prevent the system from executing an infinite iteration loop. In one example, the enterprise generative artificial intelligence system can limit the number of iterations that can be performed before the comprehension module 1106 will either provide an output result or indicate that an output result cannot be found. The user may also from feedback 1116 which can be stored in a feedback datastore 1118. The enterprise generative artificial intelligence system can, in some embodiments, use the feedback to improve the accuracy and/or reliability of the system. As discussed elsewhere herein, it will be appreciated that, in some embodiments, the functionality of comprehension modules may be included within the orchestrator.

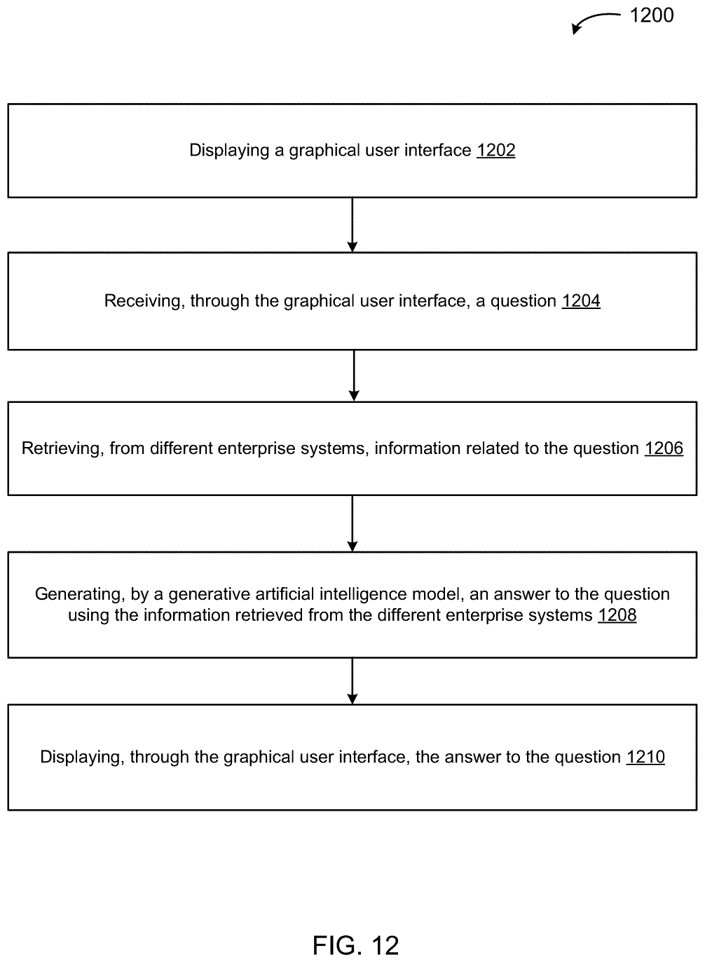

FIG. 12 depicts a flowchart 1200 of an example enterprise generative artificial intelligence method according to some embodiments. In this and other flowcharts and/or sequence diagrams, the flowchart illustrates by way of example a sequence of steps. It should be understood that some or all of the steps may be repeated, reorganized for parallel execution, and/or reordered, as applicable. Moreover, some steps that could have been included may have been removed to avoid providing too much information for the sake of clarity and some steps that were included could be removed but may have been included for the sake of illustrative clarity.

In step 1202, an enterprise system (e.g., enterprise system 804) displays a graphical user interface (GUI). In some embodiments, an interface module (e.g., interface module 930) of an enterprise generative artificial intelligence system (e.g., enterprise generative artificial intelligence system 802) may facilitate displaying the GUI. For example, the interface module may generate (e.g., render) server-side portions of the GUI, and the enterprise system may generate client-side portions of the GUI.

In step 1204, the enterprise generative artificial intelligence system receives, through the graphical user interface, a question. For example, the question may be a natural language query. In some embodiments, an orchestrator module (e.g., orchestrator module 904) receives the query.

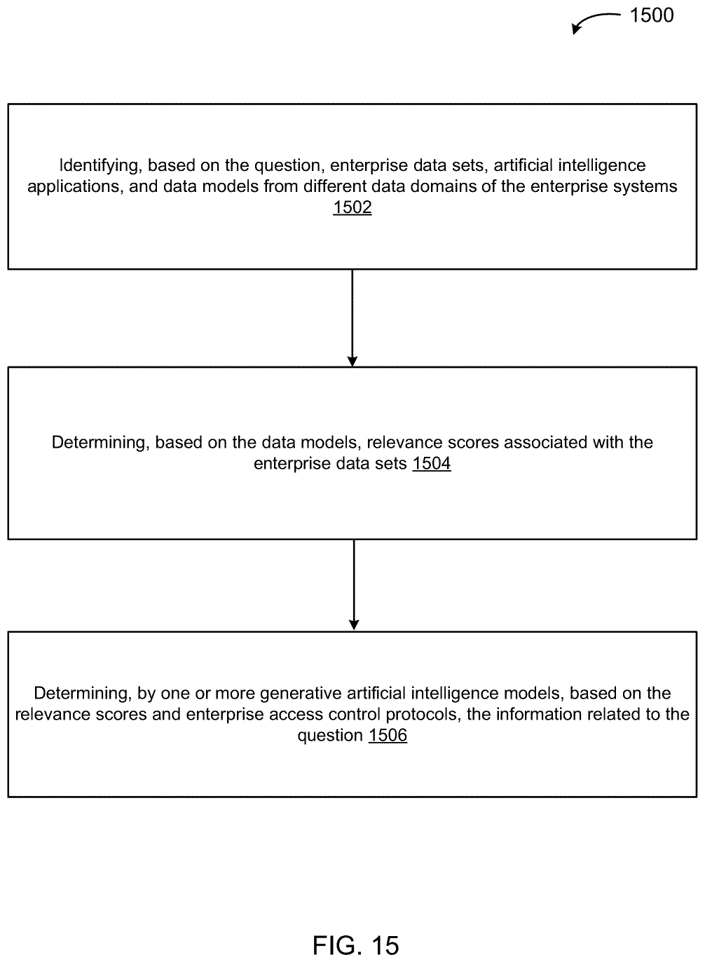

In step 1206, the enterprise generative artificial intelligence system retrieves, from different enterprise systems (e.g., enterprise systems 804), information related to the question. In some embodiments, a comprehension module (e.g., comprehension module 916) retrieves the information. An example information retrieval process is shown in FIG. 15. For example, the comprehension module 916 may cooperate with agents and/or tools to retrieve the information.

In step 1208, the enterprise generative artificial intelligence system generates, by a generative artificial intelligence model (or multiple models), an answer to the question using the information retrieved from the different enterprise systems. In some embodiments, the comprehension module generates the answer.

In step 1210, the enterprise system displays, through the graphical user interface, the answer to the question. In some embodiments, the interface module facilitates the display.

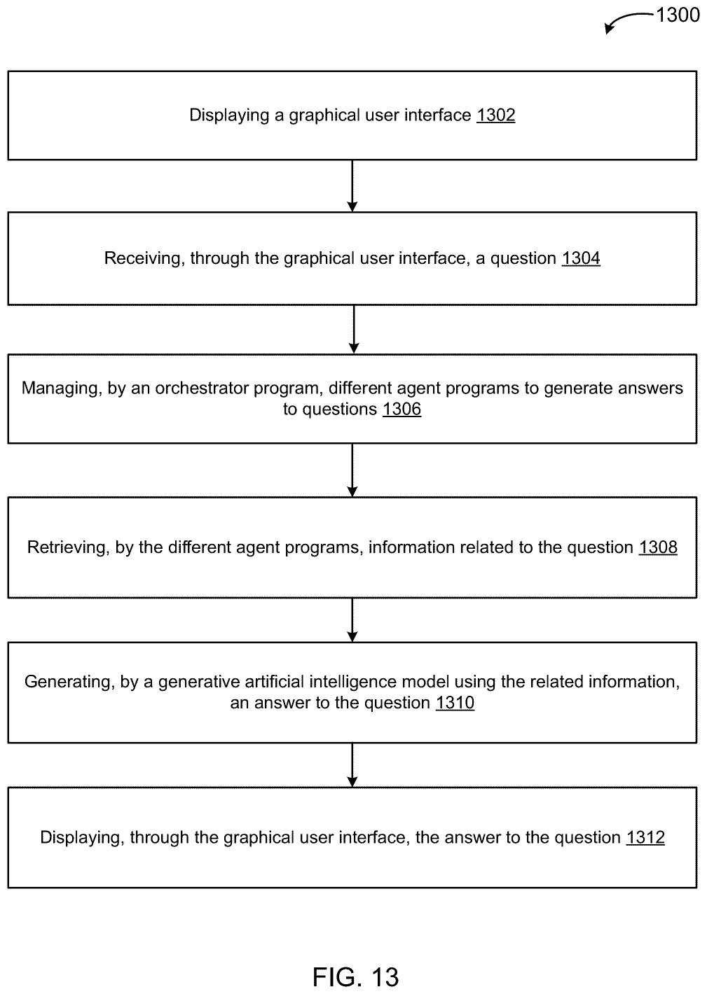

FIG. 13 depicts a flowchart 1300 of an example enterprise generative artificial intelligence method using an agent-orchestrator architecture according to some embodiments. In step 1302, an enterprise system (e.g., enterprise system 804) displays a graphical user interface (GUI). In some embodiments, an interface module (e.g., interface module 930) of an enterprise generative artificial intelligence system (e.g., enterprise generative artificial intelligence system 802) may facilitate displaying the GUI. For example, the interface module may generate (e.g., render) server-side portions of the GUI, and the enterprise system may generate client-side portions of the GUI.

In step 1304, the enterprise generative artificial intelligence system receives, through the graphical user interface, a question. For example, the question may be a natural language query. In some embodiments, an orchestrator module (e.g., orchestrator module 904) receives the query.

In step 1306, the enterprise generative artificial intelligence system manages, by an orchestrator program (e.g., orchestrator module 904), different agent programs (e.g., agent modules 906-910) to generate answers to questions. The orchestrator may use at least one multimodal model to transform the question into a series of instructions for the different agent programs to retrieve the information related to the question. The different agent programs may use one or more machine learning models to retrieve the information related to the question based on the series of instructions.

In step 1308, the enterprise generative artificial intelligence system retrieves, by the different agent programs, information related to the question. In some embodiments, retrieval agent modules 906-1 to 906-4 retrieve the information (e.g., from a vector store, enterprise systems, and/or external systems).

In step 1310, the enterprise generative artificial intelligence system generates, by a generative artificial intelligence model using the related information, an answer to the question. In some embodiments, a comprehension module (e.g., comprehension module 916) generates the answer. The generative artificial intelligence model and the multimodal model may be the same model. The generative artificial intelligence model and the multimodal model may be different models.

In step 1312, the enterprise system displays, through the graphical user interface, the answer to the question. In some embodiments, the interface module facilitates the display.

In various embodiments, managing the different agent programs may include iterative processing or multiple instructions from the orchestrator. The retrieving may include retrieving time series data, structured data, and unstructured data. The agent programs may instantiate a tool to perform an operation on the instruction, the retrieved data, or intermediate data. The agent programs may execute operations, such as calculation, translation, formatting, and/or visualization. The one or more agent programs may be trained on different domain specific machine-learning models. The agent programs may employ a type system to unify incompatible data from disparate data sources.

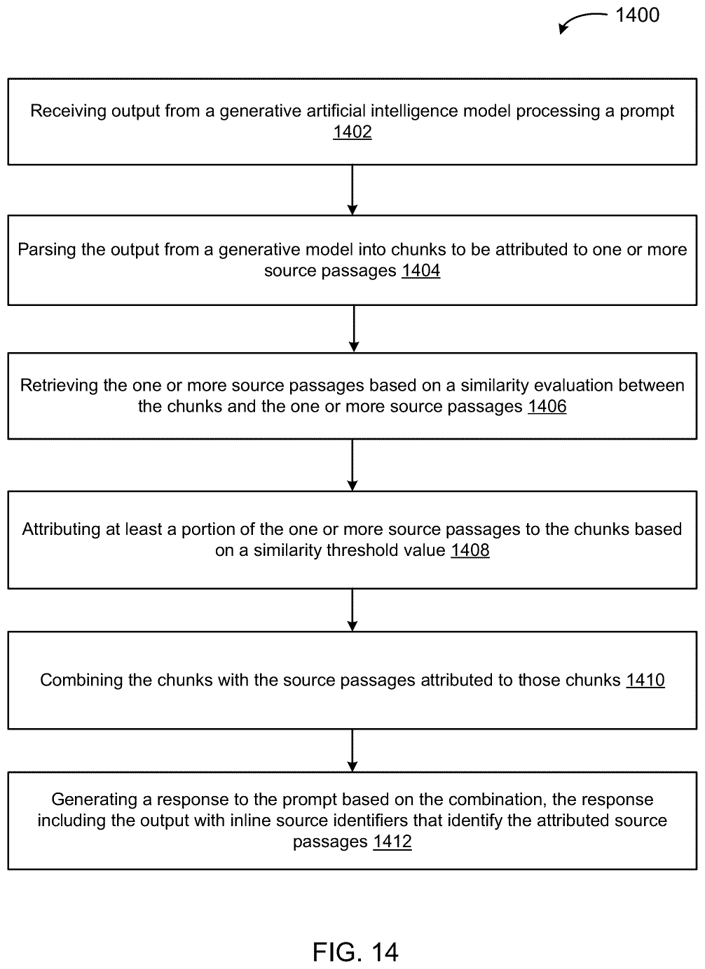

FIG. 14 depicts a flowchart 1400 of an example anti-hallucination and attribution method for enterprise generative artificial intelligence systems. In step 1402, an enterprise generative artificial intelligence system (e.g., enterprise generative artificial intelligence system 802) receives output from a generative artificial intelligence model processing a prompt. In some embodiments, an anti-hallucination and attribution module (e.g., anti-hallucination and attribution module 110) receives the output. The generative artificial intelligence model may employ a generative adversarial network, a variational autoencoder, an autoregressive model, and/or a recurrent neural network.

In step 1404, the anti-hallucination and attribution module (e.g., of the enterprise generative artificial intelligence system) parses the output from a generative model into chunks to be attributed to one or more source passages. The anti-hallucination and attribution module may be an extension of the enterprise generative artificial intelligence system and/or a component of the enterprise generative artificial intelligence system. In some embodiments, a response parser (e.g., response parser 112) parses the output into chunks.

In step 1406, the anti-hallucination and attribution module retrieves the one or more source passages based on a similarity evaluation between the chunks and the one or more source passages. In some embodiments, a retriever (e.g., anti-hallucination and attribution retriever 114) retrieves the sources passages. The retriever may include one or more machine learning models, generative artificial intelligence models, and the like. The retriever 114 may cooperate with and/or be included as part of the agents (e.g., agents 906-1, 906-2, 906-3, 906-4, etc.) and/or tools (e.g., tool 908-1, 908-2, 908-3, etc.) described herein. The similarity evaluation may be performed by the retriever 114 and/or include a similarity evaluation that calculates similarity scores associated with the chunks and the source passages.

In some embodiments, an enterprise generative artificial intelligence system (e.g., enterprise generative artificial intelligence system 802) generates an information graph (e.g., information graph 220) for each data record in a set of data records including the one or more source passages. The information graph may describe relationships between source passages and one or more other classes, the other classes including source images, source tables, and source code. The retrieving the one or more source passages may be based on the information graph (e.g., traversing the graph 220 depicted in FIG. 2).

In step 1408, the anti-hallucination and attribution module attributes at least a portion of the one or more source passages to the chunks based on a similarity threshold value. The anti-hallucination and attribution module may compare the similarity evaluation result (e.g., score) between the chunks and the one or more source passages with the similarity threshold value. For example, if a score is at or above the similarity threshold value, then the associated source passage(s) may be attributed to the chunk. In another example, if a score is below the threshold value, then the associated source passage(s) is not attributed to the chunk.

In step 1410, the anti-hallucination and attribution module combines the chunks with the source passages attributed to those chunks. This may include stitching source citations of the source passages, and/or some or all of the source passages, with the chunks.

In step 1412, the anti-hallucination and attribution module generates a response to the prompt based on the combination. The response may include the output with inline source identifiers that identify the attributed source passages. The response may include the output with at least a portion of the attributed source passages. The response may be outputted (e.g., displayed) on one or more systems (e.g., one or more enterprise systems).

In some embodiments, the output includes sentences, and the chunks may include one or more of the sentences.

FIG. 15 depicts a flowchart 1500 of an example information retrieval method for enterprise generative artificial intelligence method according to some embodiments. Like the other methods described herein, this flowchart 1500 may be combined with other flowcharts (e.g., flowchart 1200). In step 1502, an enterprise generative artificial intelligence system (e.g., enterprise generative artificial intelligence system 802) identifies, based on a received question, enterprise data sets, artificial intelligence applications, and data models from different data domains of one or more enterprise systems. The enterprise data sets may include any of documents, document segments, and insights generated by the one or more artificial intelligence applications.

In step 1504, the enterprise generative artificial intelligence system determines, based on the data models, relevance scores associated with the enterprise data sets. In some embodiments, a comprehension module (e.g., comprehension module 916) determines the relevance scores. Each of the relevance scores may be associated with a respective portion of the enterprise data sets, and wherein each of the relevance scores are determined relative to the other portions of the enterprise data sets.

In step 1506, the enterprise generative artificial intelligence system determines, by one or more generative artificial intelligence models, based on the relevance scores and one or more enterprise access control protocols, information related to the question. In some embodiments, the comprehension module determines the information (e.g., based on data retrieved by one or more agents and/or tools).

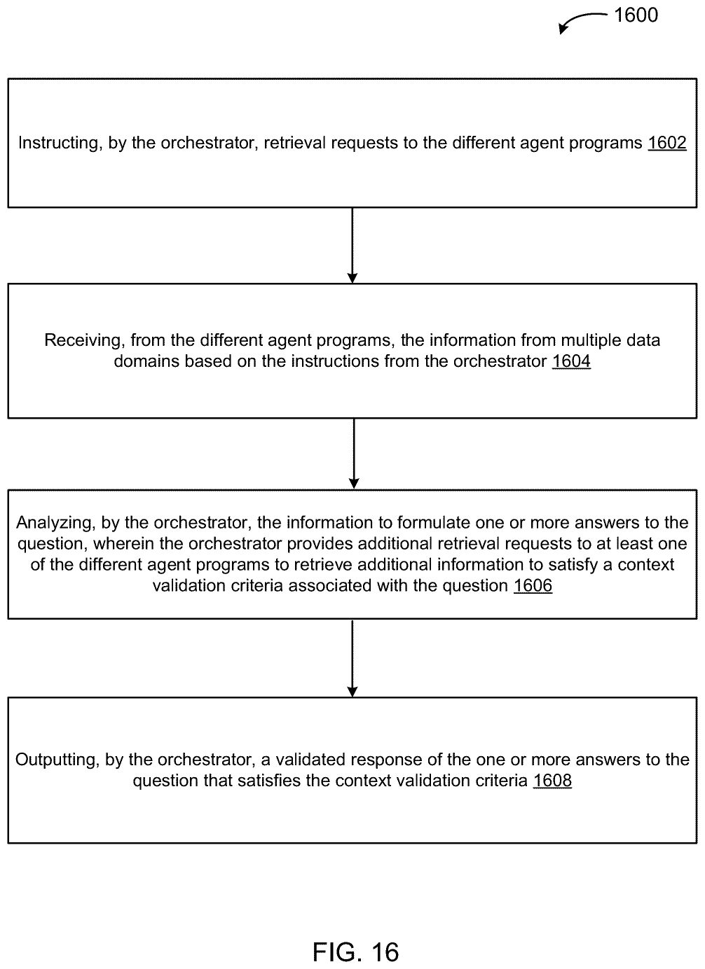

FIG. 16 depicts a flowchart 1600 of an example method of routing requests to different agent programs and validating responses for enterprise generative artificial according to some embodiments. Like the other methods described herein, this flowchart 1600 may be combined with other flowcharts (e.g., flowchart 1300). In step 1602, an orchestrator (e.g., orchestrator 904 of enterprise generative artificial intelligence system 802) instructs retrieval requests to different agent programs.

In step 1604, the enterprise generative artificial intelligence system receives, from the different agent programs, information from multiple data domains based on the instructions from the orchestrator. In some embodiments, the orchestrator module and/or comprehension module (e.g., comprehension module 916) receives the information.

In step 1606, the orchestrator analyzes the information to formulate one or more answers to the question, wherein the orchestrator provides additional retrieval requests to at least one of the different agent programs to retrieve additional information to satisfy a context validation criteria associated with the question.

In step 1608, the orchestrator outputs a validated response of the one or more answers to the question that satisfies the context validation criteria.

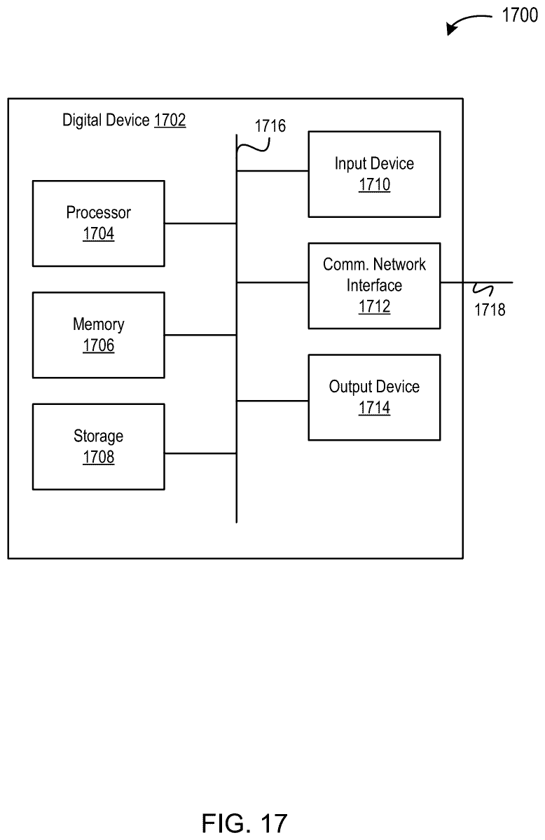

FIG. 17 depicts a diagram 1700 of an example computer system for implementing the features disclosed herein according to some embodiments. Any of the systems, engines, datastores, and/or networks described herein may comprise an instance of one or more computing devices 1702. In some embodiments, functionality of the computing device 1702 is improved to the perform some or all of the functionality described herein. The computing device 1702 comprises a processor 1704, memory 1706, storage 1708, an input device 1710, a communication network interface 1712, and an output device 1714 communicatively coupled to a communication channel 1716. The processor 1704 is configured to execute executable instructions (e.g., programs). In some embodiments, the processor 1704 comprises circuitry or any processor capable of processing the executable instructions.

The memory 1706 stores data. Some examples of memory 1706 include storage devices, such as RAM, ROM, RAM cache, virtual memory, etc. In various embodiments, working data is stored within the memory 1706. The data within the memory 1706 may be cleared or ultimately transferred to the storage 1708.

The storage 1708 includes any storage configured to retrieve and store data. Some examples of the storage 1708 include flash drives, hard drives, optical drives, cloud storage, and/or magnetic tape. Each of the memory system 1706 and the storage system 1708 comprises a computer-readable medium, which stores instructions or programs executable by processor 1704.

The input device 1710 is any device that inputs data (e.g., mouse and keyboard). The output device 1714 outputs data (e.g., a speaker or display). It will be appreciated that the storage 1708, input device 1710, and output device 1714 may be optional. For example, the routers/switchers may comprise the processor 1704 and memory 1706 as well as a device to receive and output data (e.g., the communication network interface 1712 and/or the output device 1714).

The communication network interface 1712 may be coupled to a network (e.g., network 808) via the link 1718. The communication network interface 1712 may support communication over an Ethernet connection, a serial connection, a parallel connection, and/or an ATA connection. The communication network interface 1712 may also support wireless communication (e.g., 802.11, WiMax, LTE, Wi-Fi). It will be apparent that the communication network interface 1712 may support many wired and wireless standards.

It will be appreciated that the hardware elements of the computing device 1702 are not limited to those depicted in FIG. 17. A computing device 1702 may comprise more or less hardware, software and/or firmware components than those depicted (e.g., drivers, operating systems, touch screens, biometric analyzers, and/or the like). Further, hardware elements may share functionality and still be within various embodiments described herein. In one example, encoding and/or decoding may be performed by the processor 1704 and/or a co-processor located on a GPU (i.e., NVidia).

Example types of computing devices and/or processing devices include one or more microprocessors, microcontrollers, reduced instruction set computers (RISCs), complex instruction set computers (CISCs), graphics processing units (GPUs), data processing units (DPUs), virtual processing units, associative process units (APUs), tensor processing units (TPUs), vision processing units (VPUs), neuromorphic chips, AI chips, quantum processing units (QPUs), cerebras wafer-scale engines (WSEs), digital signal processors (DSPs), application specific integrated circuits (ASICs), field programmable gate arrays (FPGAs), or discrete circuitry.

It will be appreciated that an “engine,” “system,” “datastore,” and/or “database” may comprise software, hardware, firmware, and/or circuitry. In one example, one or more software programs comprising instructions capable of being executable by a processor may perform one or more of the functions of the engines, datastores, databases, or systems described herein. In another example, circuitry may perform the same or similar functions. Alternative embodiments may comprise more, less, or functionally equivalent engines, systems, datastores, or databases, and still be within the scope of present embodiments. For example, the functionality of the various systems, engines, datastores, and/or databases may be combined or divided differently. The datastore or database may include cloud storage. It will further be appreciated that the term “or,” as used herein, may be construed in either an inclusive or exclusive sense. Moreover, plural instances may be provided for resources, operations, or structures described herein as a single instance.

The datastores described herein may be any suitable structure (e.g., an active database, a relational database, a self-referential database, a table, a matrix, an array, a flat file, a documented-oriented storage system, a non-relational No-SQL system, and the like), and may be cloud-based or otherwise. The systems, methods, engines, datastores, and/or databases described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

In an example implementation, the enterprise generative artificial intelligence systems described herein can connect to one or more virtual metadata repositories across data stores, abstracts access to disparate data sources, and supports granular data access controls is maintained by the enterprise artificial intelligence system. The enterprise generative artificial intelligence framework can manage a virtual data lake with an enterprise catalogue that connect to a multiple data domains and industry specific domains. The orchestrator of the enterprise generative artificial intelligence framework is able to create embeddings for multiple data types across multiple industry verticals and knowledge domains, and even specific enterprise knowledge. Embedding of objects in data domains of the enterprise information system enable rapid identification and complex processing with relevance scoring as well as additional functionality to enforce access, privacy, and security protocols. In some implementations, the orchestrator module can employ a variety of embedding methodologies and techniques understood by one of ordinary skill in the art. In an example implementation, the orchestrator module can use a model driven architecture for the conceptual representation of enterprise and external data sets and optional data virtualization. For example, a model driven architecture can be as described in U.S. Pat. No. 10,817,530 issued Oct. 27, 2020, Ser. No. 15/028,340 with priority to Jan. 23, 2015 titled Systems, Methods, and Devices for an Enterprise Internet-of-Things Application Development Platform by C3 AI, Inc. A type system of a model driven architecture can be used to embed objects of the data domains.

The model driven architecture handles compatibility for system objects (e.g., components, functionality, data, etc.) that can be used by the orchestrator to dynamically generate queries for conducting searches across a wide range of data domains (e.g., documents, tabular data, insights derived from AI applications, web content, or other data sources). The type system provides data accessibility, compatibility and operability with disparate systems and data. Specifically, the type system solves data operability across diversity of programming languages, inconsistent data structures, and incompatible software application programming interfaces. Type system provides data abstraction that defines extensible type models that enables new properties, relationships and functions to be added dynamically without requiring costly development cycles. The type system can be used as a domain-specific language (DSL) within a platform used by developers, applications, or UIs to access data. The type system provides interact ability with data to perform processing, predictions, or analytics based on one or more type or function definitions within the type system. The orchestrator is a mechanism for implementing search functionality across a wide variety of data domains relative to existing query modules, which are typically limited with respect to their searchable data domains (e.g., web query modules are limited to web content, file system query modules are limited to searches of file system, and so on).

Type definitions can be a canonical type declared in metadata using syntax similar to that used by types persisted in the relational or NoSQL data store. A canonical model in the type system is a model that is application agnostic (i.e., application independent), enabling all applications to communicate with each other in a common format. Unlike a standard type, canonical types are comprised of two parts, the canonical type definition and one or more transformation types. The canonical type definition defines the interface used for integration and the transformation type is responsible for transforming the canonical type to a corresponding type. Using the transformation types, the integration layer may transform a canonical type to the appropriate type.

Various embodiments of the present disclosure include systems (e.g., having one or more processors, and memory storing instructions that, when executed by the one or more processors, cause the system to perform functionality described herein), methods, and non-transitory computer-readable medium (or media) configured to perform displaying a graphical user interface; receiving, through the graphical user interface, a question; retrieving, from different enterprise systems, information related to the question; generating, by a generative artificial intelligence model, an answer to the question using the information retrieved from the different enterprise systems; and displaying, through the graphical user interface, the answer to the question. The systems, methods, and non-transitory computer-readable medium (or media) may be further configured to perform identifying, based on the question, enterprise data sets, artificial intelligence applications, and data models from different data domains of the enterprise systems; determining, based on the data models, relevance scores associated with the enterprise data sets; and determining, by one or more generative artificial intelligence models, based on the relevance scores and enterprise access control protocols, the information related to the question. The question comprises a natural language query. The enterprise data sets may include any of documents, document segments, and insights generated by the one or more artificial intelligence applications. Each of the relevance scores may be associated with a respective portion of the enterprise data sets, and wherein each of the relevance scores are determined relative to the other portions of the enterprise data sets.

Various embodiments of the present disclosure include systems (e.g., having one or more processors, and memory storing instructions that, when executed by the one or more processors, cause the system to perform functionality described herein), methods, and non-transitory computer-readable medium (or media) configured to perform displaying a graphical user interface; receiving, through the graphical user interface, a question; managing, by an orchestrator program, different agent programs to generate answers to questions; retrieving, by the different agent programs, information related to the question; generating, by a generative artificial intelligence model using the related information, an answer to the question; and displaying, through the graphical user interface, the answer to the question. The systems, methods, and non-transitory computer-readable medium (or media) may be further configured to perform instructing, by the orchestrator, retrieval requests to the different agent programs; receiving, from the different agent programs, the information from multiple data domains based on the instructions from the orchestrator; analyzing, by the orchestrator, the information to formulate one or more answers to the question, wherein the orchestrator provides additional retrieval requests to at least one of the different agent programs to retrieve additional information to satisfy a context validation criteria associated with the question; and outputting, by the orchestrator, a validated response of the one or more answers to the question that satisfies the context validation criteria.

The orchestrator may use at least one multimodal model to transform the question into a series of instructions for the different agent programs to retrieve the information related to the question. The different agent programs may use one or more machine learning models to retrieve the information related to the question based on the series of instructions. The generative artificial intelligence model and the multimodal model may be the same model. The generative artificial intelligence model and the multimodal model may be different models. In some embodiments, the systems, methods, and non-transitory computer readable media are further configured to perform generating a traceability analysis of the natural language output, the traceability analysis indicating any of the documents, the document segments, and the insights of the respective portions of the one or more enterprise data sets.

Various embodiments of the present disclosure include systems (e.g., having one or more processors, and memory storing instructions that, when executed by the one or more processors, cause the system to perform functionality described herein), methods, and non-transitory computer-readable medium (or media) configured to perform receiving output from a generative artificial intelligence model processing a prompt; parsing the output from a generative model into chunks to be attributed to one or more source passages; retrieving the one or more source passages based on a similarity evaluation between the chunks and the one or more source passages; attributing at least a portion of the one or more source passages to the chunks based on a similarity threshold value; combining the chunks with the source passages attributed to those chunks; and generating the response to the prompt based on the combination, the output including the output with inline source identifiers that identify the attributed source passages. The systems, methods, and non-transitory computer-readable medium (or media) may be further configured to perform filtering the one or more source passages based on the similarity scores; and generating an information graph for each data record in a set of data records including the one or more source passages, wherein the information graph describes relationships between source passages and one or more other classes, the other classes including source images, source tables, and source code.

The generative artificial intelligence model may employ a generative adversarial network, a variational autoencoder, an autoregressive model, or a recurrent neural network. The output may include sentences, and the chunks include one or more of the sentences. The similarity evaluation may include a similarity evaluation (e.g., cosine similarity evaluation) that calculates similarity scores associated with the chunks and the source passages. The response may be generated by a generative artificial intelligence model. The retrieving the one or more source passages may be based on the information graph.

What is claimed is:

1. A method comprising:
receiving output from a generative artificial intelligence model processing a prompt;
parsing the output from a generative model into chunks to be attributed to one or more source passages;
retrieving the one or more source passages based on a similarity evaluation between the chunks and the one or more source passages;
attributing at least a portion of the one or more source passages to the chunks based on a similarity threshold value;
combining the chunks with the source passages attributed to those chunks; and
generating a response to the prompt based on the combination, the response including the output with inline source identifiers that identify the attributed source passages.

2. The method of claim 1, wherein the generative artificial intelligence model employs a generative adversarial network, a variational autoencoder, an autoregressive model, or a recurrent neural network.

3. The method of claim 1, wherein the output includes sentences, and the chunks include one or more of the sentences.

4. The method of claim 1, wherein the similarity evaluation includes a similarity evaluation that calculates similarity scores associated with the chunks and the source passages.

5. The method of claim 1, wherein the response is generated by a generative artificial intelligence model.

6. The method of claim 4, further comprising filtering the one or more source passages based on the similarity scores.

7. The method of claim 6, further comprising:
generating an information graph for each data record in a set of data records including the one or more source passages, wherein the information graph describes relationships between source passages and one or more other classes, the other classes including source images, source tables, and source code.

8. The method of claim 7, wherein retrieving the one or more source passages is based on the information graph.

9. A system comprising:
one or more processors; and
memory storing instructions that, when executed by the one or more processors, cause the system to perform:
receiving output from a generative artificial intelligence model processing a prompt;
parsing the output from a generative model into chunks to be attributed to one or more source passages;
retrieving the one or more source passages based on a similarity evaluation between the chunks and the one or more source passages;
attributing at least a portion of the one or more source passages to the chunks based on a similarity threshold value;
combining the chunks with the source passages attributed to those chunks; and
generating a response to the prompt based on the combination, the response including the output with inline source identifiers that identify the attributed source passages.

10. The system of claim 9, wherein the generative artificial intelligence model employs a generative adversarial network, a variational autoencoder, an autoregressive model, or a recurrent neural network.

11. The system of claim 9, wherein the output includes sentences, and the chunks include one or more of the sentences.

12. The system of claim 9, wherein the similarity evaluation includes a similarity evaluation that calculates similarity scores associated with the chunks and the source passages.

13. The system of claim 9, wherein the response is generated by a generative artificial intelligence model.

14. The system of claim 12, wherein the instructions, when executed by the one or more processors, cause the system to perform filtering the one or more source passages based on the similarity scores.

15. The system of claim 14, wherein the instructions, when executed by the one or more processors, cause the system to perform generating an information graph for each data record in a set of data records including the one or more source passages, wherein the information graph describes relationships between source passages and one or more other classes, the other classes including source images, source tables, and source code.

16. The system of claim 15, wherein retrieving the one or more source passages is based on the information graph.

17. A non-transitory computer readable medium comprising instructions that, when executed, cause one or more processors to perform:
receiving output from a generative artificial intelligence model processing a prompt;
parsing the output from a generative model into chunks to be attributed to one or more source passages;
retrieving the one or more source passages based on a similarity evaluation between the chunks and the one or more source passages;
attributing at least a portion of the one or more source passages to the chunks based on a similarity threshold value;
combining the chunks with the source passages attributed to those chunks; and
generating a response to the prompt based on the combination, the response including the output with inline source identifiers that identify the attributed source passages.

18. The non-transitory computer readable medium of claim 17, wherein the generative artificial intelligence model employs a generative adversarial network, a variational autoencoder, an autoregressive model, or a recurrent neural network.

19. The non-transitory computer readable medium of claim 17, wherein the output includes sentences, and the chunks include one or more of the sentences.

20. The non-transitory computer readable medium of claim 17, wherein the similarity evaluation includes a similarity evaluation that calculates similarity scores associated with the chunks and the source passages.
